(19) United States
(12) Patent Application Publication
(10) Pub. No.: US 2026/0365816 A1
(43) Pub. Date: Nov. 19, 2026

(54) METHOD OF RECYCLING A POLYAMIDE COMPOSITION

(71) Applicant: INV NYLON CHEMICALS AMERICAS, LLC, Wilmington, DE (US)

(72) Inventors: Sudhir N.V.K. Aki, Katy, TX (US); Benjamin David Herzog, Wichita, KS (US); Gary J. Smith, North Yorkshire (GB)

(21) Appl. No.: 19/143,933

(22) PCT Filed: Mar. 9, 2024
(86) PCT No.: PCT/IB2024/052284

§ 371 Date: Jun. 27, 2025

Related U.S. Application Data
(60) Provisional application No. 63/452,774, filed on Mar. 17, 2023.

(51) Int. Cl. C08J 11/16

(52) U.S. Cl. CPC C08J 11/16

(57) ABSTRACT

A method of recycling a polyamide composition includes pre-treating the polyamide composition including a polyamide to produce a polyamide oligomer composition including polyamide oligomers having a lower molecular weight than the polyamide in the polyamide composition. The method can include subjecting the polyamide oligomer composition to ammonolysis to produce a polyamide precursor composition including polyamide oligomers and/or monomers having a lower molecular weight than the polyamide oligomers in the polyamide oligomer composition.

### CROSS-REFERENCE TO RELATED APPLICATION

This application claims the benefit of priority to U.S. Provisional Patent Application Ser. No. 63/452,774 filed Mar. 17, 2023, the disclosure of which is incorporated herein in its entirety by reference.

### FIELD

The present disclosure relates to a method for recycling a thermoplastic polymer. The method includes a pre-treatment step for obtaining low-molecular weight oligomeric intermediates products from nylon-containing feeds.

### BACKGROUND

It is becoming increasingly important to reduce the volume of scrap materials generated from post-consumer and/or post-industrial plastics use that end up in landfills. In most cases, consumer articles made from plastic components will end up in landfills or incinerators for disposal after their useful life is over. Efforts are being made to develop several technologies to break materials into constituents for reuse/recycle. In-kind recycles and Take Back programs have begun to emerge. However, circularity does not presently exist. The thermoplastics industry has a major gap in achieving circularity and a coherent approach is needed. A need still exists in the plastics recycle industry to devise practical methods to recycle polyamides, such as nylon 6, nylon 66, nylon 56, nylon 46, nylon 610, or nylon 612.

### SUMMARY OF THE INVENTION

Various aspects of the present invention provide a method of recycling a polyamide composition. The method includes pre-treating the polyamide composition including a polyamide to produce a polyamide oligomer composition including polyamide oligomers having a lower molecular weight than the polyamide in the polyamide composition. The method also includes subjecting the polyamide oligomer composition to ammonolysis to produce a polyamide precursor composition including polyamide oligomers and/or monomers having a lower molecular weight than the polyamide oligomers in the polyamide oligomer composition.

Various aspects of the present invention provide a method of recycling a polyamide composition. The method includes pre-treating the polyamide composition including a polyamide to produce a polyamide oligomer composition including polyamide oligomers having a lower molecular weight than the polyamide in the polyamide composition, wherein the pre-treating includes enzymatic treatment, sub-critical water treatment, microwave treatment, or a combination thereof. The method also includes subjecting the polyamide oligomer composition to ammonolysis to produce a polyamide precursor composition including polyamide oligomers and/or monomers having a lower molecular weight than the polyamide oligomers in the polyamide oligomer composition.

Various aspects of the present invention provide a method of recycling a polyamide composition. The method includes separating a mixed plastics stream that is greater than 5 wt % non-polyamide constituents to form a polyamide starting composition having less than or equal to 5 wt % non-polyamide constituents. The method includes mechanically treating the polyamide starting composition to produce the polyamide composition, wherein the polyamide composition has less than or equal to 5 wt % non-polyamide constituents. The method includes pre-treating the polyamide composition including a polyamide to produce a polyamide oligomer composition including polyamide oligomers having a lower molecular weight than the polyamide in the polyamide composition, wherein the pre-treating includes hot water treatment, sub-critical water treatment, super-critical water treatment, microwave treatment, enzymatic treatment, solvent dissolution, acid hydrolysis, base hydrolysis, or a combination thereof. The method also includes subjecting the polyamide oligomer composition to ammonolysis to produce a polyamide precursor composition including polyamide oligomers and/or monomers having a lower molecular weight than the polyamide oligomers in the polyamide oligomer composition.

Various aspects of the present invention provide a polyamide formed from the polyamide precursor composition of the method of recycling a polyamide composition.

Various aspects of the present invention provide a method of recycling a polyamide composition. The method includes pre-treating the polyamide composition including a polyamide to produce a polyamide oligomer composition including polyamide oligomers having a lower molecular weight than the polyamide in the polyamide composition, the pre-treating including enzymatic treatment.

Various aspects of the present invention provide a method of recycling a polyamide composition. The method includes separating a mixed plastics stream that is greater than 5 wt % non-polyamide constituents to form a polyamide starting composition having less than or equal to 5 wt % non-polyamide constituents. The method includes mechanically treating the polyamide starting composition to produce the polyamide composition, wherein the polyamide composition has less than or equal to 5 wt % non-polyamide constituents. The method also includes pre-treating the polyamide composition including a polyamide to produce a polyamide oligomer composition including polyamide oligomers having a lower molecular weight than the polyamide in the polyamide composition, wherein the pre-treating includes enzymatic treatment.

Various aspects of the present invention provide a polyamide formed from the polyamide oligomer composition of the method of recycling a polyamide composition.

Various aspects of the presently disclosed method can have advantages over other methods of recycling polyamide compositions. For example, in various aspects, the present method generates a lower concentration of side-products that are tarry or high-molecular weight and is more selective for generation of low molecular weight oligomeric intermediates than other methods of recycling polyamide compositions, which results in greater ease of processing and higher yield. In various aspects, the presently disclosed pre-treatment step can be more selective for producing lower molecular weight oligomeric intermediates than other methods for recycling polyamide compositions. In various aspects, the presently disclosed method solves the problem of thermal decomposition product formation (e.g., tars and heavy molecular weight side-products) during polyamide recycling via ammonolysis by incorporating the disclosed pre-treatment step which predigests the polyamide into the polyamide oligomer composition prior to ammonolysis, thereby providing easier processing and increased yield. In various aspects, the presently disclosed method includes a milder ammonolysis than other methods of recycling a polyamide composition, such as having lower temperatures, lower pressures, less corrosive conditions, or a combination thereof, which provides decreased production of undesired side-products.

In various aspects, the disclosed enzymatic treatment can be more specific (selective) toward formation of polyamide oligomers than currently available chemical or thermal degradation methods. For example, the disclosed enzymatic treatment can product a raw product having lower concentration of tars or high molecular weight side-products than other polyamide composition recycling methods, such as compared to a chemical or thermal degradation step operating at elevated temperature or pressure.

### BRIEF DESCRIPTION OF THE FIGURES

The drawings illustrate generally, by way of example, but not by way of limitation, various aspects of the present invention.

FIG. 1 is a simplified block flow diagram illustrating an aspect of the disclosed method.

FIG. 2 is a simplified block flow diagram illustrating an aspect of the disclosed method.

FIG. 3 is a simplified block flow diagram illustrating an aspect of the disclosed method.

FIG. 4 is a simplified block flow diagram illustrating an aspect of the disclosed method.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

As used herein, the term “polymer” refers to a molecule having at least one repeating unit and can include copolymers.

As used herein, the terms “polyamide” and “nylon” are inter-changeable and define a type of a thermoplastic polymer. Examples of polyamides or nylons include polyamide 46, polyamide 56, polyamide 66, polyamide 7, polyamide 610, polyamide 12, polyamide 612, polyamide 1212, and others.

### Method of Recycling a Polyamide Composition.

Various aspects of the present invention provide a method of recycling a polyamide composition. The method includes pre-treating the polyamide composition including a polyamide to produce a polyamide oligomer composition including polyamide oligomers having a lower molecular weight than the polyamide in the polyamide composition. The method can also include subjecting the polyamide oligomer composition to ammonolysis to produce a polyamide precursor composition including polyamide oligomers and/or monomers having a lower molecular weight than the polyamide oligomers in the polyamide oligomer composition.

The polyamide composition can be a uniform composition. The uniform composition can include uniform-sized solids, a semi-solid slurry, a slurry solution, a homogenized liquid solution of dissolved polymer, or a combination thereof. The polyamide composition can be a particulate composition. The particles can have any suitable shape, such as round particle, irregular particles, strips, or a combination thereof. The particles can have a d₅₀ particle size of less than 100 mm, less than 50 mm, less than 5 mm, or less than 1 mm. The method can include mechanically treating a polyamide starting composition to form the polyamide composition. The polyamide starting composition can have the same composition as the polyamide composition. The mechanical treatment can include size reduction, cutting, grinding, shredding, particle formation, or a combination thereof. For example, the mechanical treatment can produce a uniform composition and/or a particulate composition.

The method can include separating a mixed plastics stream that is greater than 5 wt % non-polyamide constituents to form the polyamide composition having less than or equal to 5 wt % non-polyamide constituents. The separating can include melting point separation, stain test separation, electrostatic separation, flotation separation, melt phase separation, hot water pressure technique, hot dissolution technique, cold dissolution technique, selective dissolution technique, or a combination thereof. In some aspects, the separating includes flotation separation in water. The separating of the mixed plastics stream can remove thermoset polymers, polyesters, polyolefins, polycarbonates, or a combination thereof, from polyamide in the mixed plastics stream. For example, the separating of the mixed plastics stream can remove PET, LDPE, LLDPE, PP, PVC, ABS rubber, polyacrylates, or a combination thereof, from polyamide in the mixed plastics stream.

The polyamide can be reinforced (e.g., glass fiber-reinforced polyamide) or can be substantially free of reinforcements. The polyamide is a condensation polyamide. One example of a suitable condensation polyamide is the condensation product of adipic acid and hexamethylene diamine, commonly known as nylon 66 or poly-(hexamethylene adipamide). Another example of a suitable condensation polyamide is the condensation product of caprolactam, commonly known as nylon 6 or poly-(caprolactam). Yet another example of a suitable condensation polyamide is the condensation product of adipic acid and pentamethylenediamine, commonly known as nylon 56 or poly-(pentamethylene adipamide). The condensation product of sebacic acid and hexamethylene diamine, commonly known as nylon 610 or poly-(hexamethylene sebacamide), is another example of a suitable condensation polyamide. Other condensation polyamides can be produced by varying the chain length and composition of an organic diacid and a diamine to produce a variety of condensation polyamides with properties tailored for various end-uses.

The polyamide in the polyamide composition can include any suitable polyamide or nylon. For example, the polyamide in the polyamide composition can include N4, N5, N6, N7, N10, N11, N12, N46, N56, N66, N610, N612, or a combination thereof. The polyamide in the polyamide composition can include N6, N66, N56, N610, or a combination thereof. The polyamide in the polyamide composition can include N66. In various aspects, the polyamide in the polyamide composition includes N4, N5, N6, N7, N10, N11, N12, N46, N56, N66, N610, N612, or a combination thereof, and the polyamide composition is substantially free of other polyamides. The polyamide can be 80 wt % to 100 wt % of the polyamide composition, or 95 wt % to 100 wt %, or 98 wt % to 100 wt %, or less than or equal to 100 wt % and greater than or equal to 80 wt % and less than, equal to, or greater than 82, 84, 86, 88, 90, 92, 94, 95, 95.5, 96, 96.5, 97, 97.5, 98, 98.5, 99, 99.2, 99.4, 99.6, 99.8, or 99.9 wt %.

The method includes pre-treating the polyamide composition including a polyamide to produce a polyamide oligomer composition including polyamide oligomers having a lower molecular weight than the polyamide in the polyamide composition. The pre-treating can depolymerize a nylon polymer into its corresponding oligomeric intermediate components. The depolymerization can be partial (e.g., light) such that predominantly oligomers are formed rather than monomers. The pre-treating can include hot water treatment, sub-critical water treatment, super-critical water treatment, microwave treatment, enzymatic treatment, solvent dissolution, acid hydrolysis, base hydrolysis, or a combination thereof. The pre-treating can include solvent dissolution, acid hydrolysis, base hydrolysis, or a combination thereof. The pre-treating can include enzymatic treatment, sub-critical water treatment, microwave treatment, or a combination thereof. The pre-treating can be performed for any suitable duration. The pre-treating can be performed for a duration of no more than 15 h, such as 1 min to 15 h, or 1 h to 15 h, or 5 h to 15 h, or less than or equal to 15 h and greater than or equal to 1 min and less than, equal to, or greater than 5 min, 10, 20, 30, 40, 50 min, 1 h, 1.5, 2, 4, 6, 8, 10, 12, or 14 h. In various aspects, the produced polyamide oligomer composition can have a d₅₀ molecular weight that is at least 10 times lower than the d₅₀ for the polyamide composition fed to the pre-treatment. In various aspects, the polyamide can be washed or otherwise cleansed of various impurities prior to the pre-treatment.

The pre-treating can include enzymatic treatment. In some aspects, the enzymatic treatment can be an enzymatic treatment described in International Biodeterioration & Biodegradation, Vol. 60, p 144-151 (2007), by Sudhakar et al, hereby incorporated by reference in its entirety, in which degradation of nylon 6 and 66 was demonstrated in mineral salt medium at 35 °C and pH of 7.5 under submerged enrichment conditions with the polymer as the sole carbon source. Table 1 in Sudhakar et al., provides a literature summary of similar microbe degradation of nylon 66 and 6. Such process steps can be included in the pre-treatment as in the present disclosure.

The enzymatic treatment can be performed at a temperature of 15 °C to 45 °C, or 20 °C to 30 °C, or less than or equal to 45 °C and greater than or equal to 15 °C and less than, equal to, or greater than 16, 18, 20, 21, 22, 23, 24, 25, 26, 27, 28, 29, 30, 32, 34, 36, 38, 40, 42, or 44 °C. The enzymatic treatment can be performed at a pressure of 0.5 atm to 2 atm, or 1 atm to 1.5 atm, or less than or equal to 2 atm and greater than or equal to 0.5 atm and less than, equal to, or greater than 0.6 atm, 0.7, 0.8, 0.9, 1, 1.1, 1.2, 1.3, 1.4, 1.5, 1.6, 1.7, 1.8, or 1.9 atm. The enzymatic treatment can be performed at a pH of about 5 to about 9, such as less than or equal to 9 and greater than or equal to 5 and less than, equal to, or greater than 5.5, 6, 6.5, 7, 7.5, 8, 8.5, or 9. In an aspect, the enzymatic treatment can operate in a vessel that requires no ASTM pressure rating. The enzyme treatment can produce a product having a lower concentration of tars (e.g., high molecular weight side products).

The pre-treating can include sub-critical water treatment. The sub-critical water treatment can include treatment with water having a temperature of 200 °C to <373.9 °C, or 200 °C to 300 °C, or less than 373.9 °C and greater than or equal to 200 °C and less than, equal to, or greater than 210 °C, 220, 230, 240, 250, 260, 270, 280, 290, 300, 310, 320, 330, 340, 350, 360, or 370 °C. The sub-critical water treatment can include treatment with water having a pressure of 20 atm to 217.8 atm, or 40 atm to 100 atm, or less than or equal to 217.8 atm and greater than or equal to 20 atm and less than, equal to, or greater than 30 atm, 40, 50, 60, 70, 80, 90, 100, 110, 120, 130, 140, 150, 160, 170, 180, 190, 200, or 210 atm. In one aspect, a sub-critical water condition can include about 250-300 °C temperature and about 65-75 atm pressure range and between 0.5-6 h of treatment.

The pre-treating can include microwave treatment. The microwave treatment can include subjecting to microwave energy in a solvent at a temperature of 100 °C to 500 °C, or 150 °C to 250 °C, or less than or equal to 500 °C and greater than or equal to 100 °C and less than, equal to, or greater than 120 °C, 140, 150, 160, 170, 180, 190, 200, 210, 220, 230, 240, 250, 260, 280, 300, 350, 400, or 450 °C. The microwave treatment can be performed at a pressure of 1 atm to 1,000 atm, or 20 atm to 80 atm, or less than or equal to 1,000 atm and greater than or equal to 1 atm and less than, equal to, or greater than 10 atm, 20, 30, 40, 50, 60, 70, 80, 90, 100, 120, 140, 160, 180, 200, 250, 300, 400, 500, 600, or 800 atm. The solvent can be any suitable solvent, such as an alcohol or glycol, such as methanol or ethylene glycol. In one aspect, a microwave treatment can include about 190-250 °C temperature and about 20-100 atm pressure range and between 0.1-3 h of treatment time.

In yet another aspect, about 10 wt. % of nylon 66 in water can be partially hydrolyzed at 270 °C and 57 atm for about 1 hour to produce sufficient oligomers being 80% soluble in boiling water. The partial nylon hydrolysis may also be carried out in the presence of a heterogeneous acid catalyst, such as strong acid Amberlyst™ resin.

The polyamide oligomer composition includes polyamide oligomers having a lower molecular weight than the polyamide in the polyamide composition. The polyamide oligomer composition can include dimers, trimers, tetramers, higher oligomers, or a combination thereof. The polyamide oligomer composition can have a number-average molecular weight of polyamide oligomers therein of greater than or equal to 200 g/mol to less than or equal to 3,000 g/mol, >200 g/mol to <3,000 g/mol, >300 g/mol to <2,800 g/mol, >400 g/mol to <2,500 g/mol, >500 g/mol to <2,000 g/mol, >500 g/mol to <1,800 g/mol, or greater than or equal to 500 g/mol to less than or equal to 1,500 g/mol, or less than or equal to 3,000 g/mol and greater than or equal to 500 g/mol and less than, equal to, or greater than 600 g/mol, 700, 800, 900, 1,000, 1,100, 1,200, 1,300, 1,400, 1,500, 1,600, 1,700, 1,800, 2,000, 2,200, 2,400, 2,600, or 2,800 g/mol. The method can further include dewatering the polyamide oligomer composition to remove water therefrom.

The method can also include subjecting the polyamide oligomer composition to ammonolysis to produce a polyamide precursor composition including polyamide oligomers and/or monomers having a lower molecular weight than the polyamide oligomers in the polyamide oligomer composition. The ammonolysis can include contacting the polyamide oligomer composition with a nitrogen source. The nitrogen source can be any suitable nitrogen source for ammonolysis, such as gaseous ammonia, liquid ammonia, dissolved ammonia, ammoniacal solution, and ammonia-enriched medium, or a combination thereof. The nitrogen source can include gaseous ammonia. The ammonolysis can include contacting the polyamide oligomer composition with the nitrogen source at a reaction temperature of 200 °C to 350 °C, or less than or equal to 350 °C and greater than or equal to 200 °C and less than, equal to, or greater than 210 °C, 220, 230, 240, 250, 260, 270, 280, 290, 300, 310, 320, 330, or 340 °C. The ammonolysis can include contacting the polyamide oligomer composition with the nitrogen source at a reaction pressure of 500 to 2,000 Psig (34-136 atm), or less than or equal to 140 atm and greater than or equal to 30 atm and less than, equal to, or greater than 40 atm, 50, 60, 70, 80, 90, 100, 110, 120, or 130 atm. The method can further include recovering, purifying, and recycling unreacted nitrogen source back for reuse in the ammonolysis.

The ammonolysis of a nylon 66 polymer produces a mixture of two types of oligomers: one containing an amide group, the other an amine group. The amide groups undergo dehydration to nitriles, or nitrilation, under the conditions of the reaction. The ammonolysis reaction is chemical equilibrium-limited and is favored by high concentrations of ammonia (nitrogen source), removal of the volatile HMD eventually formed by stripping with excess ammonia, and conversion of the amides to nitriles. Nitrilation is also chemical equilibrium-limited and is favored by the removal of the water and the ADN from the reaction mixture. The ammonolysis of Nylon 6 largely produces caprolactam (CPLM), aminocapronitrile (ACN or N112), and 6-aminocaproamide (ACAM). However, cyclic dimers can also form under the conditions of the reaction and nitrile groups are also active in producing undesirable by-products.

During ammonolysis, it is possible that thermal degradation of the amide, acid, nitrile and amine constituents present in the system can generate tars, CO₂ and a slew of other unwanted by-products. The generation of tarry, degradation substances are highly undesirable in any chemical reaction system. These substances, not only result in lowering the desired product yields, but also cause operational and processing difficulties. The presently disclosed method solves this problem of thermal decomposition products formation during nylon recycle by ammonolysis. The presently disclosed ammonolysis of the low molecular weight oligomeric/monomeric intermediates obtained from a partial nylon depolymerization pre-treatment can result in superior ammonolysis performance in terms of the monomer yield and ease of processing. The generation of high-molecular weight tarry substances can be reduced, thereby, improving the overall product yields.

The polyamide precursor composition can include polyamide monomers, polyamide oligomers, or a combination thereof. The polyamide precursor composition can include polyamide monomers and can be substantially free of polyamide oligomers. Polyamide monomers can be 0 wt % to 100 wt % or 1 wt % 100 wt % of a total amount of polyamide monomers and polyamide oligomers in the polyamide precursor composition, or 90 wt % to 100 wt %, or less than or equal to 100 wt and greater than or equal to 80 wt % and less than, equal to, or greater than 82 wt %, 84, 86, 88, 90, 92, 94, 95, 96, 97, 98, 99, or 99.9 wt %. The polyamide precursor composition can include any suitable polyamide monomer corresponding to the polyamide subjected to the method, such as hexamethylene diamine (HMD), aminocapronitrile, 6-aminocaproamide, dimethyl adipate, adipic acid, methyl 6-aminocaproate, or a combination thereof.

The method can further include purifying, refining, or separating one or more components of the polyamide precursor composition.

The method can further include polymerizing the polyamide precursor composition or one or more components thereof to form one or more polyamides.

Various aspects of the present invention provide a method of recycling a polyamide composition that can be performed without performing ammonolysis. The method can include pre-treating the polyamide composition including a polyamide to produce a polyamide oligomer composition including polyamide oligomers having a lower molecular weight than the polyamide in the polyamide composition, the pre-treating including enzymatic treatment. The polyamide in the polyamide composition can include N4, N5, N6, N7, N10, N11, N12, N46, N56, N66, N610, N612, or a combination thereof. The polyamide can be 95 wt % to 100 wt % of the polyamide composition, or 98 wt % to 100 wt %, or less than or equal to 100 wt % and greater than or equal to 80 wt % and less than, equal to, or greater than 82 wt %, 84, 86, 88, 90, 92, 94, 95, 96, 97, 98, 99, or 99.9 wt %. The enzymatic treatment can be performed at a temperature of 15 °C to 45 °C, 20 °C to 30 °C, or less than or equal to 45 °C and greater than or equal to 15 °C and less than, equal to, or greater than 16, 18, 20, 21, 22, 23, 24, 25, 26, 27, 28, 29, 30, 32, 34, 36, 38, 40, 42, or 44 °C, and at a pressure of 0.5 atm to 2 atm, or 1 atm to 1.5 atm, or less than or equal to 2 atm and greater than or equal to 0.5 atm and less than, equal to, or greater than 0.6 atm, 0.7, 0.8, 0.9, 1, 1.1, 1.2, 1.3, 1.4, 1.5, 1.6, 1.7, 1.8, or 1.9 atm. The enzymatic treatment can be performed at a pH of about 5 to 9, such as less than or equal to 9 and greater than or equal to 5 and less than, equal to, or greater than 5.5, 6, 6.5, 7, 7.5, 8, or 8.5. The enzymatic treatment can be performed for a duration of no more than 15 hours, such as 1 min to 15 h, or 1 h to 15 h, or 5 h to 15 h, or less than or equal to 15 h and greater than or equal to 1 min and less than, equal to, or greater than 5 min, 10, 20, 30, 40, 50 min, 1 h, 1.5, 2, 4, 6, 8, 10, 12, or 14 h. The polyamide oligomer composition can include dimers, trimers, tetramers, higher oligomers, or a combination thereof. The polyamide oligomer composition can have a number-average molecular weight of polyamide oligomers therein of greater than or equal to 200 g/mol to less than or equal to 3,000 g/mol, or greater than or equal to 500 g/mol to less than or equal to 1,500 g/mol, or less than or equal to 3,000 g/mol and greater than or equal to 500 g/mol and less than, equal to, or greater than 600 g/mol, 700, 800, 900, 1,000, 1,100, 1,200, 1,300, 1,400, 1,500, 1,600, 1,700, 1,800, 2,000, 2,200, 2,400, 2,600, or 2,800 g/mol. The method can further include dewatering the polyamide oligomer composition. The method can further include polymerizing the polyamide oligomer composition to form one or more polyamides therefrom.

The method can further include mechanically treating a polyamide starting composition to form the polyamide composition, such as to form a uniform composition and/or particulate composition. The method can further include separating a mixed plastics stream that is greater than 5 wt % non-polyamide constituents to form the polyamide composition having less than or equal to 5 wt % non-polyamide constituents.

In various aspects, the method of recycling the polyamide composition including enzymatic treatment can be free of ammonolysis. In other aspects, the method includes subjecting the polyamide oligomer composition to ammonolysis to produce a polyamide precursor composition including polyamide oligomers and/or monomers having a lower molecular weight than the polyamide oligomers in the polyamide oligomer composition. The ammonolysis can include contacting the polyamide oligomer composition with a nitrogen source. The nitrogen source can include gaseous ammonia, liquid ammonia, dissolved ammonia, ammoniacal solution, and ammonia-enriched medium, or a combination thereof. The nitrogen source can be gaseous ammonia. The ammonolysis can include contacting the polyamide oligomer composition with the nitrogen source at a reaction temperature of 200 °C to 350 °C, or less than or equal to 350 °C and greater than or equal to 200 °C and less than, equal to, or greater than 210 °C, 220, 230, 240, 250, 260, 270, 280, 290, 300, 310, 320, 330, or 340 °C, and at a reaction pressure of 500 to 2,000 Psig (34-136 atm), or less than or equal to 140 atm and greater than or equal to 30 atm and less than, equal to, or greater than 40 atm, 50, 60, 70, 80, 90, 100, 110, 120, or 130 atm. The method can further include recovering, purifying, and recycling unreacted nitrogen source back for reuse in the ammonolysis. The method can further include polymerizing the polyamide precursor composition to form one or more polyamides therefrom.

The disclosed method provides a practical solution for recycling a nylon polymer. The disclosed method can be effective in depolymerizing a variety of nylon constituents, present in the mixed plastics stream, into their corresponding monomeric constituents. Further recovery and purification of these monomers yield pure products that are suitable for re-use by recycling back in the nylon production facilities. For example, nylon 66 can be processed in the disclosed method to produce purified hexamethylenediamine and adipic acid. Nylon 6 can be processed in the disclosed method to produce caprolactam. In one example, nylon 56 can be processed in the disclosed method to produce purified pentamethylenediamine and adipic acid. These monomers can be re-used in the processes that produce these nylons. The disclosed method, therefore, is beneficial for reducing the landfill mass, and at the same time, offering circularity and carbon footprint optimization to the nylon industry.

### Polyamide.

Various aspects of the present invention provide a polyamide formed from a polyamide precursor composition or polyamide oligomer composition formed by the presently disclosed method of recycling a polyamide composition.

In various aspects, the polyamide can be formed from a polyamide precursor composition formed by a method that includes pre-treating the polyamide composition including a polyamide to produce a polyamide oligomer composition including polyamide oligomers having a lower molecular weight than the polyamide in the polyamide composition. The method can also include subjecting the polyamide oligomer composition to ammonolysis to produce the polyamide precursor composition including polyamide oligomers and/or monomers having a lower molecular weight than the polyamide oligomers in the polyamide oligomer composition.

In various aspects, the polyamide can be formed from a polyamide oligomer composition formed by a method that includes pre-treating the polyamide composition including a polyamide to produce the polyamide oligomer composition including polyamide oligomers having a lower molecular weight than the polyamide in the polyamide composition, the pre-treating including enzymatic treatment.

In various aspects, the polyamide can be formed from a polyamide precursor composition that includes pre-treating the polyamide composition including a polyamide to produce a polyamide oligomer composition including polyamide oligomers having a lower molecular weight than the polyamide in the polyamide composition, the pre-treating including enzymatic treatment. The method also includes subjecting the polyamide oligomer composition to ammonolysis to produce the polyamide precursor composition including polyamide oligomers and/or monomers having a lower molecular weight than the polyamide oligomers in the polyamide oligomer composition.

### EXAMPLES

Various aspects of the present invention can be better understood by reference to the following Examples which are offered by way of illustration. The present invention is not limited to the Examples given herein.

Abbreviations. Adipic acid (AA); aminocapronitrile (ACN); aminocaproamide (ACAM); adiponitrile (ADN); bis-Hexamethylene triamine (BHMT); a dimer of caprolactam (CLDIM); caprolactam (CPLM); cyanovaleramide (CVAM); a dimer of aminocapronitrile and aminocaproamide (DNAC); hexamethylenediamine (HMD); hexamethyleneimine (HMI); polycaprolactam, polyamide 6, or nylon 6 (N6 or PA6); poly(hexamethylene adipamide), polyamide 66, or nylon 6 (N6,6, N66, or PA66).

Materials used in the Examples. The test specimen for Nylon 66 or “N6,6”, as used in the examples, was obtained from INVISTA Nylon 66 production facility. The reported number-averaged molecular weight (Mn) of this material was determined to be about 14,000 g/mole (via NMR) and the relative viscosity (RV) was about 36.5 (as determined via 8.4% concentration in 90% formic acid as per ASTM D789). The nylon 6,6 material, used herein, represents a commercial polymer used in a variety of applications including airbag and textile fibers. Commercially available materials, namely, formic acid, aqueous ammonium hydroxide, methanol and ethylene glycol were used in the examples. The test specimen for Nylon 6 or “N6”, as used in the examples, was a commercially available material. The nylon 6 and nylon 66 polymer specimens were mechanically ground in a blender with dry ice. The powdery ground polymer specimens were easy to load in 25 ml test containers.

Test methods used in the Examples: Analytical techniques used: GC was used for the monomeric components, GC-MS was used for speciation of the unknowns; NMR was used for molecular chain ends analysis and molecular weight (Mn) determination; LC-MS was used for speciation of the oligomeric constituents; FT-IR was used for oligomeric identification; DSC was used for melting point characterization; TGA was used for the determination of the volatile components.

The analytical samples for NMR were prepared by dissolving about 0.02 g of solid per about 0.050 g of trifluoroacetic acid (TFA), and then a deuterated methylene chloride (CD₂Cl₂) was added to about 1 g of the TFA-dissolved polymer sample.

The analytical samples for LC-MS were prepared as follows: about 0.01-0.02 g of recovered solids were dissolved in Hexafluoro isopropyl alcohol (HFIP). The low-molecular weight oligomeric intermediates were solubilized in HFIP. The solution was filtered and analyzed by LC-MS.

### Example 1. Breakdown of Polyamide via Solvent Dissolution, Acid/Base Treatment, or Enzymatic Treatment

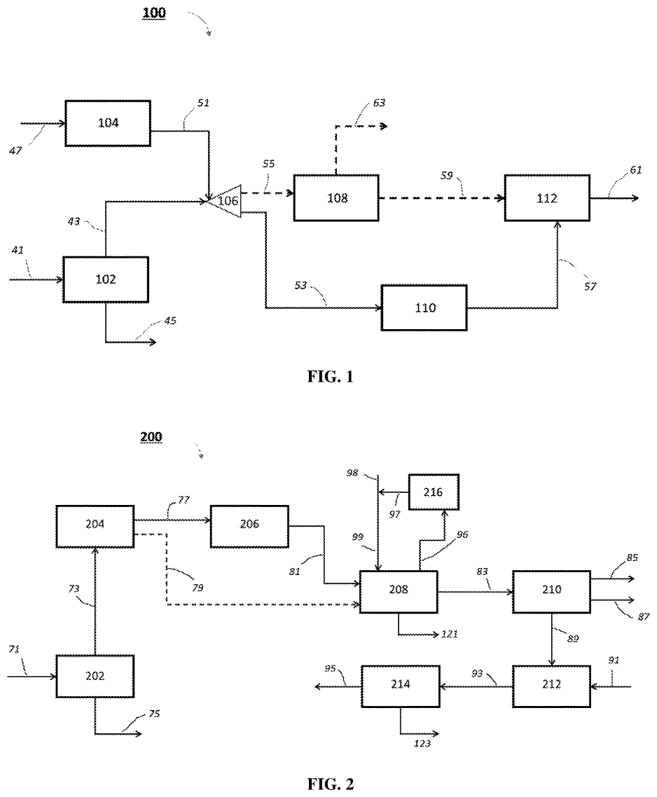

In aspect 100 shown in FIG. 1, a mixed plastics stream 41 contains thermoplastic and thermoset materials. The materials contain various end-of-use/end-of-life parts and articles, either in their spent form and/or partially shredded forms. The thermoplastic components include reinforced and non-reinforced nylons (polyamides), polyesters (mainly PET), polyolefins (LDPE, LLDPE, polypropylene or PP), or polycarbonates. The thermoset components include PVC, ABS rubber and polyacrylates.

The mixed plastics stream 41 undergoes several steps of sorting/separation 102 that separate the thermoplastic from the thermoset materials. In 102 once the thermoplastics are separated, this stream undergoes further segregation to separate polyamides such as N6 N66 from other non-polyamides such as PP and PET, and to separate polyamides from each other. The separation can include melting point separation, stain test separation, electrostatic separation, flotation separation, melt phase separation, hot water pressure technique, hot dissolution technique, cold dissolution technique, selective dissolution technique, or a combination thereof, as described below.

Melting point separation can be conducted based on the melting points of PP (156 °C), N6 (220 °C), N66 and PET (>256 °C). N66 and PET can be further separated by a stain test, wherein N66 is acid dyeable while PET is not.

Apparel and carpet fibers produced by methods such as shearing or shredding can be further classified by electrostatic separation. Nylon fibers are more susceptible to electrostatic charges than PP.

In flotation separation, for example, the material may be suspended in a liquid (e.g., water) having a density between that of PP (0.93 g/cc) and nylon 6 (1.12 g/cc)/nylon 66 (1.13 g/cc). The floating PP portion can be skimmed/filtered off from the top.

The plastic material may be melted and allowed to phase separate. The molten PP floating on top may be skimmed/decanted, while the nylon melt may be recovered at the bottom. Small amounts of adipic acid or hexamethylenediamine may be added to lower the nylon melt viscosity by end-capping and then neutralizing.

The hot water pressure technique (150-300 Psig; 170-200 °C) may be used to separate non-nylon materials, mainly, such as polyester, jute, PP, and the like, from the nylon components. Nylon 66 tends to melt at about 170 °C in the presence of high-pressure water, while nylon 6 and PP melt at about 150 °C and 175 °C, respectively. Polyester and jute remain unaffected by these conditions.

In the hot dissolution technique, the material is contacted with hot (>150 °C) high boiling solvent (with low vapor pressure). Nylon is allowed to dissolve while PP melts under these conditions. The PP floats on the top and may be skimmed/decanted when solvent density is higher than PP. Other materials heavier than the solvent density may settle to the bottom and may be filtered out. The hot dissolved nylon solution may undergo chemical treatment to depolymerize into monomeric precursors or oligomers of value. Alternatively, cooling the solution may result in polymer precipitation followed by filtration. Suitable solvents include those boiling above 100 °C at atmospheric pressure, for example those, boiling >150 °C at atmospheric pressure.

In the cold dissolution technique, the material is contacted with a solvent capable of dissolving nylon at low temperatures (<150 °C, and suitably at ambient temperature). Once the nylon components are dissolved, the insoluble non-nylon components may be filtered out of the solution. Nylon resin may be recovered by stripping solvent (using steam or vacuum) or by non-solvent dilution. Suitable solvents include those boiling at <150 °C, at atmospheric pressure.

A selective dissolution technique may be used wherein the plastic material is contacted with a solvent selective for nylon 6 (or 66) at a controlled temperature. The nylon 6 containing solution is separated by filtration and cooled (or diluted with non-solvent) to precipitate nylon 6. The remaining nylon 66 material may be treated with the same (or different) solvent at a higher temperature to dissolve to nylon 66 from PP and other materials. As an illustration, methanol/water mixtures selectively dissolve nylon 6 from nylon 66 at 120-150 °C, while also dissolving nylon 66 above 150 °C. In each case, the dissolved polymer would precipitate as powder upon cooling to room temperature. Other solvents may include benzyl alcohol, tetramethylene sulfone and butane-1,4-diol.

The combination of any or all above steps would segregate the nylon components from non-nylon components.

The segregated nylon components stream 43 obtained from the gathering/separation step 102 is next fed to a chemical solutioning step 108. A separate mechanical pre-treatment step 104 can accept a mixed nylon-containing feed stream 47 and pre-treats the stream to produce a feed stream 51 suitable for step 108. Stream 51 can contain shredded or size-reduced carpet/apparel fibers, automotive parts, engineering polymer articles, and the like.

In step 108 compatible solvent dissolution along with acid/base hydrolysis chemistries are utilized to cause a chemical breakdown of long nylon chains into smaller chunks, thereby, producing nylon oligomers (or short-chain nylon constituents) stream 55. There may be other by-product streams 63 generated during this process and can be recovered for sale or used as fuel.

Alternatively, the segregated nylon components stream 53 from the gathering/separation 102 as well as stream 51 from mechanical pre-treatment 104 may undergo an enzymatic bio-degradation step 110, such as that described in International Biodeterioration & Biodegradation, Vol. 60, p 144-151 (2007), by Sudhakar et al., and resulting in short-chain, low molecular weight nylon monomeric or oligomeric constituents (such as dimers, trimers, tetramers, and the like) stream 57. Although not shown, it is also possible to feed stream 59 exiting from step 108 to the enzymatic bio-degradation step 110. These short-chain nylon oligomeric materials, either in stream 57 or stream 59, may be easy to re-polymerize in the subsequent step 112. The repolymerized material stream 61 may be recovered from the re-polymerization step 112 as either in ground state, in pellet, fiber, or other usable form. The nylon polymer stream 61 would have a recycled nylon content that comes from the mixed plastics stream 41 and/or from the mixed nylon-containing feed stream 47.

### Example 2. Breakdown of Polyamide via Pre-Treatment and Ammonolysis

This example illustrates a method of recycling a nylon-containing feed 71 to obtain refined diamine product 95 that is available for nylon polymerization. As shown in FIG. 2, in aspect 200, a pre-treatment step 206 for nylon oligomeric intermediates can be used ahead of an ammonolysis step 208. Depending on the feed stream 77 quality and process economic considerations, step 206 can be an enzymatic bio-treatment, sub-critical water treatment, a microwave digestion treatment, or a combination thereof.

It may be possible to feed the nylon materials stream 79, obtained from gathering/separation step 202 and mechanical pre-treatment step 204 (as described in Example 1) to the ammonolysis step 208. However, such mixed feedstock may contain elevated levels of contaminants that may adversely impact the ammonolysis process. The pre-treatment step 206 can be effective in producing a consistent low-molecular weight nylon oligomeric stream 81 that would be advantageous for the ammonolysis step 208. The ammonolysis step can operate with excess ammonia inlet stream 99. An ammonia recovery step 216 can collect the ammonia-rich gaseous effluent 96 and purify it to form ammonia recycle stream 97. A make-up ammonia stream 98 maintains the ammonia balance across the ammonolysis step, with streams 97 and 98 combining to form stream 99 fed to step 208. The heavies and tar-like substances may be recovered form step 208 and purged out as stream 121 and used for fuel value.

The ammonolysis process effluent 83 may contain the primary nylon monomers, such as diamine, adipic acid precursors (e.g., cyano-amides or dinitriles) along with a variety of other precursors (e.g., aminonitriles, mono and dinitriles, lactams, and the like). A refining step 210 can process the ammonolysis effluent stream 83 to recover such components in high purity, for example, a lactam stream 85 or an aminonitrile stream 87. The remaining effluent stream 89 may undergo one or more chemical transformations (e.g., reductive amination or hydrogenation) in step 212 with hydrogen source 91 and generate a consistent diamine-rich stream 93. The diamine-rich stream 93 may be further purified in step 214 to obtain a refined diamine stream 95 with suitable purity for end-use applications. The diamine-lean side-products 123 may also have utility in the nylon field.

### Example 3. Breakdown of Polyamide via Solvent Dissolution and/or Acid/Base Treatment Followed by Pre-Treatment

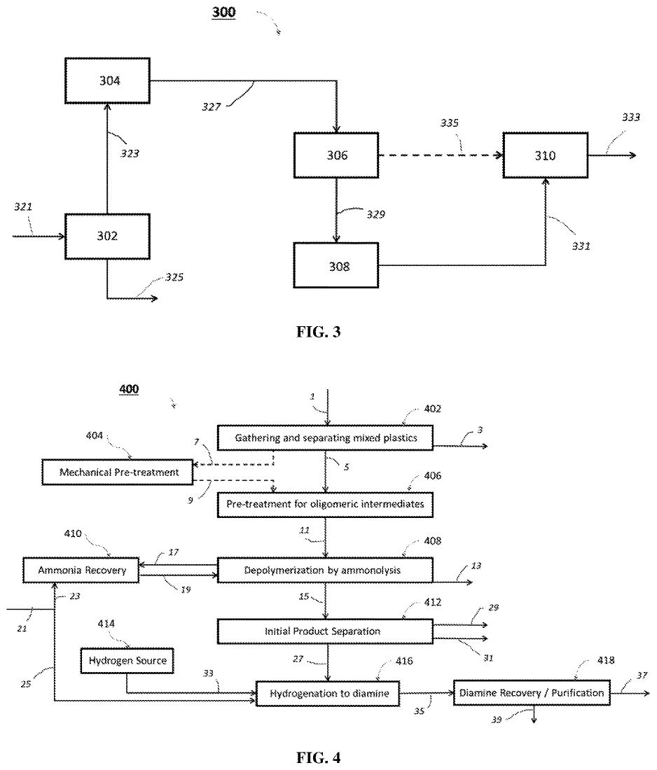

As shown in FIG. 3, an effluent 329 from a chemical solutioning step 306 (including solvent dissolution, acid/base hydrolysis, or a combination thereof) can be fed to a pre-treatment step 308 instead of being directly fed to a re-polymerization step 310 (as shown as dotted line 335). The pre-treatment step 308 includes enzymatic bio-treatment, sub-critical water treatment, a microwave digestion treatment, or a combination thereof. The pre-treatment step 308 may produce a consistent stream 331 of short-chain, low molecular weight nylon oligomers that can be advantageous for re-polymerization step 310. The nylon polymer stream 333 obtained from step 310 would have a recycled nylon content that comes from the mixed plastics stream 321 that is first separated in gathering/separation step 302 as a mixed-nylon stream 323 and non-nylon plastics stream 325. Step 202 is a gathering/separation step to produce stream 323, and step 304 represents a mechanical pre-treatment step that produces a uniform mixed-nylon feedstock 327 from the mixed-nylon stream 323 that can contain post-industrial recycled (PIR) and/or post-consumer recycled (PCR) textile/apparel fibers, automotive parts, airbag fabric, and the like.

### Example 4. Sub-Critical Water Pre-Treatment for Nylon Oligomeric Intermediates

About 1.2 grams of nylon polymer mixed in with about 22.5 cc of deionized water was held for 1 h and 6 h, and at about 275 °C temperature and no more than 68 atm (1000 Psig) pressure in a 25 ml stainless steel closed container. These temperature and pressure conditions result in a sub-critical water test condition. The sub-critical water condition is known as the condition below the critical point of water (i.e., 373.95 °C and 217.75 atm (3200.1 Psia)).

The nylon polymer specimens tested were nylon 6, labeled as “N6”, and nylon 66, labeled as “N6,6”. The resulting product was separated into a liquid phase and a solid phase by filtration. The liquid phase was analyzed by GC-MS, NMR and LC-MS for speciation and quantification. The recovered solid phase was dissolved in suitable solvents and the homogenized solution was analyzed by LC-MS and NMR. The “as is” solids were used in the FT-IR, DSC and TGA analyses.

The test conditions included three media, namely, i) a neutral medium (water), ii) an acidic 0.01 M formic acid medium, and iii) a basic 0.01 M ammonium hydroxide medium. For each test condition, a blank sample was run with a polymer sample in water. Table 1 illustrates the measured speciation from GC-MS and LC-MS analysis. Table 2 illustrates the measured weight yields that were observed. Table 3 illustrates the number-averaged molecular weight (Mn) reduction from the tests performed.

TABLE 1
Measured speciation from GC-MS and LC-MS analysis.

| | | | | | | Caprolactam | |
|---|---|---|---|---|---|---|---|
| Example | | | HMD | HMI | BHMT | (area, | Calc. monomers |
| ID. | Polymer/Conditions | Test | (wt. %) | (wt. %) | (wt. %) | pA*minª) | (HMD + AA), g* |
| 4a | N6,6/water (1 hour) | Blank | 0 | 0 | 0 | n/a | 0 |
| 4b | (neutral medium) | Subcritical | 0.199 | 0.0052 | 0 | n/a | 0.087 |
| 4c | N6,6/0.01M formic | Blank | 0 | 0 | 0 | n/a | 0 |
| 4d | acid (1 hour) | Subcritical | 0.083 | 0.0008 | 0 | n/a | 0.036 |
| 4e | N6,6/0.01M | Blank | 0 | 0 | 0 | n/a | 0 |
| | ammonium hydroxide | | | | | | |
| 4f | (1 hour) | Subcritical | 0.153 | 0.003 | 0 | n/a | 0.067 |
| 4g | N6,6/water (6 hours) | Run 1 | 0.561 | 0.0794 | 0.0148 | n/a | 0.246 |
| 4h | (neutral medium) | Run 2 | 0.651 | 0.1783 | 0.0128 | n/a | 0.285 |
| 4i | N6/water (6 hours) | Run 1 | 0 | 0 | 0.0058 | 40.48 | n/a |
| 4j | (neutral medium) | Run 2 | 0 | 0 | 0.0055 | 53.41 | n/a |

^{a}values represent the integrated areas from GC-FID detector response.
*only monomers (HMD and Adipic Acid or AA) are accounted for and not including the oligomers.
All wt % are based on the total sample weight (1.2 g polymer + 22.5 cc D.I Water totaling about 23.7 g).

TABLE 2
Measured weight yields.

| | | | Weight | Weight | | |
|---|---|---|---|---|---|---|
| | | | before | after | | |
| Example | | | the test | the test | De-polymerized | Calc. monomers |
| ID. | Polymer/Conditions | | (g) | (g) | By diff (%) | (HMD + AA) (%) |
| 4b | N6,6/water (1 hour) | | 1.2 | 0.662 | 44.9 | 7.3 |
| 4d | N6,6/0.01M formic acid | | 1.2 | 0.959 | 20.1 | 4.6 |
| | (1 hour) | | | | | |
| 4f | N6,6/0.01M ammonium | | 1.2 | 0.709 | 40.9 | 8.5 |
| | hydroxide (1 hour) | | | | | |
| 4g | Nylon 6,6/water | Run 1 | 1.2 | 0.227 | 81.1 | 20.5 |
| 4h | (6 hours) | Run 2 | 1.2 | 0.101 | 91.6 | 23.8 |
| 4i | Nylon 6/water | Run 1 | 1.2 | 0.027 | 97.8 | n/a |
| 4j | (6 hours) | Run 2 | 1.2 | 0.164 | 86.3 | n/a |

TABLE 3
Number-averaged molecular weight (Mn) reduction.

| | | | Mn (g/mol) of |
|---|---|---|---|
| Example | | | end-of-run solids |
| ID. | Polymer/Conditions | Test | (1 h run-time) |
| 4a | N6,6/water (1 hour) | Blank | 14,343 |
| 4b | | Sub-critical | 1,076 |
| 4c | N6,6/0.01M formic | Blank | 16,328 |
| 4d | acid (1 hour) | Sub-critical | 931 |
| 4e | N6,6/0.01M ammonium | Blank | 15,343 |
| 4f | hydroxide | Sub-critical | 1,046 |
| | (1 hour) | | |

It was observed that the neutral medium tests resulted in good HMD yields from N6,6 depolymerization. In all tests at sub-critical conditions, formation of HMD, adipic acid and oligomers was observed from N6,6 depolymerization. The comparison between Example 4b and Examples 4g-4h showed higher monomer and oligomeric product yields as the run-time increased from 1 h to 6 h with other things kept the same. The 6 h runs also showed increased side-products, for example, HMI and BHMT, compared to the 1 h test results. The N6 depolymerization test Example 4i and 4j mostly yielded caprolactam.

Molecular weight (Mn) determination. In each instance of Table 3 the end-of-run (1 h run-time) solids were filtered from the test medium. The recovered solids were analyzed by ¹H-NMR to determine the terminal and in-chain HMD segments, and the terminal and in-chain adipic acid segments. From these measurements the % HMD and % adipic acid in chain-ends were determined. The % HMD chain-ends values were used in estimating the molecular weight (Mn) values.

These examples indicate promising results wherein nylon polymers can be effectively depolymerized at sub-critical conditions into their respective monomers and oligomers. A 10× or higher molecular weight reduction from the starting nylon polymer feed to its monomeric and oligomeric constituents was observed in these examples.

The obtained monomers, for example, HMD and adipic acid in the case of N6,6, and caprolactam in the case of N6, can be recovered from the product and are available for recycle. The at least 10× reduced molecular weight oligomers can suitably undergo further reactions for depolymerizing into additional monomeric products.

### Examples 5a-5j. Microwave Pre-Treatment for Nylon Oligomeric Intermediates

A lab-scale, single reaction chamber Microwave Digestion System (Model: UltraWAVE; Manufacturer: Milestone Inc.) apparatus was used in these examples. The apparatus was equipped with a microwave reaction monitoring panel and a multiple test setup to run parallel reactions at once. All nylon depolymerization tests were run for 1 h at about 210 °C temperature and a maximum pressure of about 50 atm pressure.

Three depolymerization test media were used in this Example: i) neutral, ii) acidic (0.01 M formic acid) and iii) basic (0.01 M ammonium hydroxide). Two solvents were also tested: methanol and ethylene glycol. The microwave depolymerization tests were run with about 0.1 gram of polymer mixed in with about 3 cc of either one selected test medium or solvent. The tested polymers included N6 and N6,6. At the end of each run a representative liquid sample of the product was analyzed using GC and GC-MS methods. Table 4 illustrates the measured speciation from GC-MS and LC-MS analysis.

TABLE 4
Measured speciation from GC-MS and LC-MS analysis.

| | | Polymer | Medium/ | | | | Caprolactam |
|---|---|---|---|---|---|---|---|
| Example | Polymer/Conditions | Weight | Solvent | HMI | HMD | BHMT | (area, |
| ID. | (1 h run-time) | (g) | (g) | (wt. %) | (wt. %) | (wt. %) | pA*min) |
| 5a | N6,6/water | 0.10 | 3.21 | 0.005 | 0.015 | 0.006 | n/a |
| 5b | N6,6/0.01M NH₄OH | 0.10 | 3.07 | 0.007 | 0.042 | 0.007 | n/a |
| 5c | N6,6/0.01M formic | 0.10 | 3.02 | 0.015 | 0.072 | 0.005 | n/a |
| | acid | | | | | | |
| 5d | N6,6/methanol | 0.11 | 3.02 | 0 | 0.003 | 0.007 | n/a |
| 5e | N6,6/ethylene Glycol | 0.11 | 3.02 | 0.149 | 0.132 | 0.027 | n/a |
| 5f | N6/water | 0.10 | 3.72 | n/a | n/a | 0.008 | 3.671 |
| 5g | N6/0.01M NH₄OH | 0.12 | 3.07 | n/a | n/a | 0.005 | 3.136 |
| 5h | N6/0.01M formic | 0.10 | 3.04 | n/a | n/a | 0.005 | 9.606 |
| | acid | | | | | | |
| 5i | N6/methanol | 0.10 | 3.03 | n/a | n/a | 0.005 | 5.104 |
| 5j | N6/ethylene glycol | 0.10 | 3.04 | 0.006 | n/a | 0.005 | 1.617 |

This Example indicates promising results wherein nylon polymers can be reasonably depolymerized by microwave technique into their respective monomers and oligomers. The monomers, for example, HMD in the case of N6,6, and caprolactam in the case of N6, can be recovered from the product and are available for recycle. The reduced molecular weight oligomers can suitably undergo further reactions for depolymerizing into additional monomeric products.

### Example 6. Breakdown of Polyamide via Pre-Treatment and Ammonolysis

FIG. 4 is a schematic representation of a method 400 for recycling nylon polymer. The method 400 includes step 402 of gathering and separating a mixed plastics stream 1 into a non-nylon plastics stream 3 and a mixed nylon stream 5. The mixed plastics stream 1 may originate from residential/community/industrial recycling facilities, post-consumer recycled (PCR) streams, post-industrial recycled (PIR) streams, and the like. The mixed plastics stream 1 may contain such polyolefin materials as HDPE, LDPE, LLDPE, polypropylene, polybutylene; such polyester materials as PET, PBT; polycarbonate materials; such acrylic materials as ABS, acrylates; polystyrene materials; such polyamide materials as nylons, aramid nylons; polyurethane materials, and other such thermoset materials as natural rubber, synthetic rubber, EPDM, VITON, PVC, and the like.

Step 402 may include such physical washing and separation techniques as water/solvent washing, flotation separation, gravity separation, electrostatic separation, melt-phase separation, separation by hot/cold dissolution, selective solvent dissolution, the combinations thereof. Example 1 describes some of these mixed plastics separation techniques. The combination of any or all such techniques would segregate the nylon components from non-nylon components of stream 1.

The non-nylon plastics stream 3 may include non-nylon plastic constituents such as polyethylene, polypropylene, polybutylene, polycarbonate, polyurethane, polyester, and like. The mixed-nylon stream 5 may contain nylon 6, nylon 66, nylon 6X, nylon X6, and like constituents. The symbol “X”, as used herein, means a variety of dicarboxylic acids or diamines used in the preparation of nylons. In one illustration, the X value of 10 in nylon 6X may represent a C₁₀ dicarboxylic acid polymerized with hexamethylenediamine (HMD or HMDA) to make nylon 610. In another illustration, the X value of 5 in nylon X6 may represent a five-carbon diamine, pentamethylenediamine (PMD or PMDA), polymerized with adipic acid to make nylon 56. In yet another illustration, the X value of 12 in nylon 6X may represent a C₁₂ dicarboxylic acid polymerized with hexamethylene diamine to make nylon 612. Such abbreviations and nomenclatures for nylons are generally practiced in the thermoplastics industry.

The nylon source may also include post-industrial recycle (PIR) materials, post-consumer recycle (PCR) materials, virgin off-spec nylon materials from the production facilities, or a combination thereof. In one instance, the mixed-nylon stream 5 may include materials from end-of-life automotive, electrical & electronics, textile articles/parts, or a combination thereof. Another mixed-nylon source can be engineering polymer articles/parts that may contain reinforcement, for example, glass fibers, natural and cellulosic fibers, basalt fibers, or a combination thereof.

An optional step 404 of mechanical pre-treatment may take a partial mixed nylon stream 7 from step 402 to produce a nylon stream 9 that contains uniformly size reduced nylon pieces for acceptance to a step that follows. Many conventional size reduction techniques are known and practiced in the solids management industry. Step 404 may include such conventional methods as fiber/fabric stripping, shredding, chomping, crushing, breaking, cutting, grinding, milling, pelletization, or a combination thereof. Some techniques are dry processes, while some are wet processes that use water and/or other solvents.

The method 400 includes step 406 of pre-treating the nylon materials to obtain low-molecular weight oligomeric intermediates. Step 406 processes the mixed nylon stream 5 (and/or stream 9) and converts the individual nylon constituents into their respective smaller oligomeric constituents as oligomeric intermediates stream 11. Step 406 can include the nylon depolymerization pre-treatment step according to those described in Examples 4 and 5.

In one instance, step 406 can contain a sub-critical water depolymerization condition, as demonstrated in Examples 4b, 4d, 4f, and 4g-4j. The resulting product contains some monomeric and a mixture of dimeric, trimeric, tetrameric, or other oligomeric constituents from depolymerizations carried out in step 406. As demonstrated in Examples 4, high-molecular weight nylon 66 effectively breaks down to the HMD and adipic acid monomers, along with its corresponding oligomeric mixture having a number-averaged molecular weight (Mn) of at least 10× lower than the nylon 66 that was fed. Similarly, high-molecular weight Nylon 6 effectively breaks down to its caprolactam monomer, along with its corresponding oligomeric mixture having a significantly lower number-averaged molecular weight (Mn) than the nylon 6 that was fed.

In another instance, step 406 can contain a microwave-assisted depolymerization condition, as demonstrated in Examples 5. The resulting product contains some monomeric and a mixture of dimeric, trimeric, tetrameric, or other oligomeric constituents from depolymerizations carried out in step 406. As demonstrated in Examples 5, high-molecular weight nylon 66 effectively breaks down to HMD and adipic acid monomers, along with its corresponding oligomeric mixture having a much lower number-averaged molecular weight (Mn) than the nylon 66 that was fed. Similarly, high-molecular weight nylon 6 effectively breaks down to its caprolactam monomer, along with its corresponding oligomeric mixture having a significantly lower number-averaged molecular weight (Mn) than the nylon 6 that was fed.

Step 406 pre-treats the high-molecular nylon materials and produces the oligomeric intermediates stream 11 that is enriched in monomeric and low-molecular weight oligomeric constituents from whichever nylon that is fed to step 406. In one aspect, nylon 56, when fed to step 406, would result in its respective monomeric and low-molecular weight oligomeric constituents. In another aspect, the excess water removal sub-step can be included at the end of step 406 to dehydrate the oligomeric intermediates stream 11 and before feeding to the next step.

Step 406 is, therefore, useful to obtain low-molecular nylon depolymerization streams in the disclosed method 400.

The method 400 includes step 408 for the complete break-down of the low-molecular weight oligomeric intermediates stream 11 into monomeric stream 15. Step 408 employs either catalyzed or un-catalyzed ammonolysis processing in the presence of ammonia. The nylon ammonolysis is described in the present disclosure and in Examples 7 and 8, therefore, not repeated here. The ammonia management for step 408 is via a fresh ammonia feed supply stream 23 to an ammonia recovery step 410. A non-condensable vaporous stream 17 is collected from step 408 that contains the excess ammonia. The ammonia recovery step 410 concentrates and purifies the excess ammonia from stream 17 and returns back to the ammonolysis step 408 as an ammonia recycle stream 19. A fresh make-up ammonia stream 21 is regulated to maintain proper ammonia mass balance in the method 400.

The ammonolysis depolymerization step 408 can produce small amounts of the tarry, high-molecular weight, and heavy constituents. Such heavies and high molecular weight side products made in step 408 can be concentrated via a combination of distillative separation, steam stripping, and extraction, and are purged out of the method 400 as a heavies/high boilers purge stream 13. In one instance, the concentrated stream 13 can be a pyrolysis oil that, upon high-temperature cracking, can be upgraded to hydrogen and synthesis gas. In another instance, stream 13 can be useful as a by-product fuel for its heat value in boilers for steam generation.

The monomeric stream 15, exiting the ammonolysis step 408, can contain various nylon monomers and precursors as described in Example 7. Some non-limiting examples of the nylon monomers and precursors may include lactams (e.g., caprolactam from nylon 6 or laurolactam from nylon 12); dinitriles (e.g., butanedinitrile, pentanedinitrile, or hexanedinitrile); diamines (e.g., butanediamine, pentanediamine, hexanediamine, decanediamine, or dodecanediamine); amides (e.g., adipamide); amino-nitriles (e.g., amino-butanenitrile, amino-pentanenitrile, or amino-hexanenitrile); cyano-amides (e.g., cyanovaleramide or cyanocaproamide); various dimers in small amounts; or a combination thereof.

The method 400 includes an initial product separation step 412 for recovering easily separable monomers and precursors from the monomeric stream 15 exiting step 408. Step 412 may include one or more sequential and/or parallel distillation, decantation, and extraction sub-steps to separate out the monomer constituents based on their boiling points and extraction efficacies. For example, a semi-purified stream 29 can contain the lactams, while stream 31 can contain either one or several small molecule aminonitriles and diamines, either recovered as individual components or produced as a mixture. These monomers and intermediates may find uses in their respective polymer productions as recycle streams. For example, the recovered caprolactam in stream 29 can be further purified and recycled to a nylon 6 production facility. In another example, the recovered butanediamine in stream 31 can be further purified and recycled to a nylon 46 production facility.

The hexanedinitrile, hexanediamine, and amino-hexanenitrile constituents can be separated and concentrated in a hydrogenation feed stream 27 exiting the initial product separation step 412. The method 400 includes a hydrogenation step 416 for converting the hydrogenation feed stream 27 to a diamine. A hydrogen source step 414 provides the hydrogen via stream 33 and an ammonia feed stream 25 is supplied from the fresh make-up ammonia stream 21. The hydrogenation step 416 can be catalytic or non-catalytic, and can be a low-, medium or high-pressure step. Several hydrogenation methods can include, for example, fixed-bed catalytic systems, slurry catalytic systems, solvent-assisted catalytic systems, or a combination thereof. In one instance, 1,6-hexanedinitrile can be hydrogenated in ammonia presence at 4500-5000 Psig pressures and 100-200 °C temperatures using a reduced iron-based catalytic system. In another instance, amino-hexanenitrile can be hydrogenated in ammonia presence at 500-1500 Psig pressures and 60-150 °C temperatures using a Raney® Nickel or Raney® Cobalt catalytic system.

The hydrogenated product stream 35 from step 416 is further purified in a diamine recovery/purification step 418 of the method 400. Step 418 may employ various sub-steps, such as diamine distillation based on the component relative volatilities, ion exchange technology, extraction using preferential solvent(s), melt crystallization, or a combination thereof. Step 418 produces a diamine product stream 37 that meets or exceeds the purity specification for downstream application. For example, the diamine product stream 37 can be a refined HMD product of greater than 99.9 wt % purity. Such HMD product is suitable for recycle back to any of the nylon 6X production facilities, for example, to make nylon 66, nylon 69, nylon 610, nylon 612, or other 6X nylons.

The disclosed method 400 is effective in recycling nylon polymers by converting them to their corresponding monomeric constituents and making them available with sufficient purity for recycle back in the nylon production. Disclosed method 400 provides environmental and sustainability advantages.

### Example 7. Breakdown of Polyamide via Ammonolysis with No Pre-Treatment

Method 400 for recycling nylon polymer, as described in Example 6 and schematically represented in FIG. 4, is performed except the pre-treatment step 406 for oligomeric intermediates. The nylon-containing stream, obtained from step 402 and/or step 404, is fed directly to the ammonolysis step 408 for nylon depolymerization in the presence of excess ammonia.

Tables 5A-5G below summarize the depolymerization by ammonolysis for the nylon feeds as tested. About 15 grams of starting nylon polymer undergoes depolymerization by ammonolysis in excess ammonia for each test run. About 1.46 g/min of gaseous ammonia is continuously fed to the reaction for the total run-time in each case. The ammonolysis reaction temperature is varied from 225 °C to 350 °C. The ammonolysis reaction time is monitored to achieve at least 50% conversion of the starting material at each temperature. The ammonolysis step is operated at about 68 atm (1000 Psig) pressure. The ammonolysis step operates in a continuous-stirred tank reactor (CSTR) mode.

The vapor and liquid products obtained from the ammonolysis test are summarized in the tables for each of the nylon-containing feeds, namely, nylon 66 (Tables 5A-5B); nylon 6 (Tables 5C-5D); and a 50:50 (wt:wt) mixed nylon 66:nylon 6 (Tables 5E-5G).

In Tables 5A-5G, the following definitions are used: Conversion, %=(Mass fed, g—Mass unconverted, g)/(Mass fed, g)×100; Monomers Yield, %, for nylon 66 containing feed: Yield, %=(moles of ADN+HMD+CVAM)/(moles of polymer fed)×100; Monomers Yield, %, for nylon 6 containing feed: Yield, %=(moles of CPLM+ACN+ACAM)/(moles of polymer fed)×100. Overall monomers % yield for a mixed feed containing nylon 6 and nylon 66=(Monomers % Yield from nylon 66 containing feed)×wt. % of nylon 66 fraction in the mixed feed+(Monomers % Yield from nylon 6 containing feed)×wt. % of nylon 6 fraction in the mixed feed. The term “Tars” represents a collection of high-boiling, and in some cases, high molecular weight components that are formed, for example from the oligomerization of components having the nitrile end groups.

TABLE 5A
Ammonolysis of N66-containing feed.

| | Ammonolysis Conditions | | | | | | | |
|---|---|---|---|---|---|---|---|---|
| | | | Total | | | | | Ammonolysis |
| | | | NH₃ | Unconverted | | | Tars | Products |
| Ex. | Temp, | Time, | fed, | Mass in | Conversion | Monomers | Formed | Vapor- |
| ID. | °C | mins | g | reactor, g | % | Yield, % | % | phase, g |
| 8a | 225 | 600 | 876 | 4.8 | 67.9 | 67.4 | 17.0 | 896.3 |
| 8b | 250 | 410 | 599 | 4.2 | 72.0 | 71.4 | 48.1 | 620.1 |
| 8c | 275 | 350 | 511 | 4.0 | 73.5 | 72.6 | 75.5 | 532.9 |
| 8d | 300 | 300 | 438 | 4.6 | 69.5 | 65.0 | 84.4 | 458.5 |
| 8e | 325 | 250 | 365 | 5.7 | 61.8 | 54.2 | 84.3 | 382.9 |
| 8f | 350 | 150 | 219 | 7.9 | 47.3 | 38.1 | 83.5 | 232.3 |

TABLE 5B
Ammonolysis of N66-containing feed.

| | | Ammonolysis Step Products | | | | | | | | | |
|---|---|---|---|---|---|---|---|---|---|---|---|
| Ex. | Temp, | in vapor-phase, wt. % | | | | | | in liquid-phase, wt. % | | | |
| ID. | °C | NH₃⁽*⁾ | ADN | HMD | CVAM | Water | Other⁽\hat{ }⁾ | NH₃^{(&)} | CO₂^{(&)} | Tars | Other⁽\hat{ }⁾ |
| 8a | 225 | 97.6 | 0.4 | 0.7 | 0.1 | 0.2 | 1.1 | 82.5 | 0.3 | 17.0 | 0.1 |
| 8b | 250 | 96.3 | 0.7 | 1.0 | 0.1 | 0.3 | 1.7 | 49.7 | 1.8 | 48.1 | 0.4 |
| 8c | 275 | 95.6 | 0.8 | 1.1 | 0.1 | 0.3 | 2.0 | 19.5 | 4.9 | 75.5 | <0.1 |
| 8d | 300 | 95.2 | 0.9 | 1.1 | 0.1 | 0.4 | 2.3 | 7.5 | 8.1 | 84.4 | <0.1 |
| 8e | 325 | 95.1 | 1.0 | 1.0 | 0.1 | 0.4 | 2.4 | 4.6 | 11.1 | 84.3 | <0.1 |
| 8f | 350 | 94.1 | 1.3 | 1.1 | 0.1 | 0.5 | 2.9 | 3.5 | 13.0 | 83.5 | <0.1 |

⁽*⁾The excess NH₃ can be recovered and recycled back to the ammonolysis step via step 410 (as shown in FIG. 4).
⁽\hat{ }⁾The term “Other” includes adipamide, and dimers of HMD with adipamide and CVAM.
^{(&)}The NH₃ and CO₂ values represent the components likely present in the dissolved state in liquid-phase.
The liquid-phase wt. % values are based on the remaining liquid mass at the end that excludes the unconverted polymer mass.

TABLE 5C
Ammonolysis of N6-containing feed.

| | Ammonolysis | | | | | | | |
|---|---|---|---|---|---|---|---|---|
| | Conditions | | | | | | | Ammonolysis |
| | | | Total | Unconverted | | | Tars | Products |
| Ex. | Temp, | Time, | NH₃ | Mass in | Conversion | Monomers | Formed | Vapor-phase, |
| ID. | °C | mins | fed, g | reactor, g | % | Yield, % | % | g |
| 8a | 225 | 550 | 803 | 3.8 | 74.5 | 74.4 | 2.3 | 825.3 |
| 8b | 250 | 450 | 657 | 4.6 | 69.1 | 68.9 | 3.5 | 677.6 |
| 8c | 275 | 390 | 570 | 2.1 | 86.2 | 86.0 | 18.7 | 592.5 |
| 8d | 300 | 250 | 365 | 1.8 | 88.0 | 85.6 | 39.0 | 387.8 |
| 8e | 325 | 210 | 307 | 1.6 | 89.6 | 86.1 | 52.0 | 328.7 |
| 8f | 350 | 170 | 320 | 1.5 | 89.9 | 86.7 | 71.3 | 269.5 |

TABLE 5D
Ammonolysis of N6-containing feed.

| | | Ammonolysis Step Products | | | | | | | | | | |
|---|---|---|---|---|---|---|---|---|---|---|---|---|
| Ex. | Temp, | in vapor-phase, wt. % | | | | | | in liquid-phase, wt. % | | | | |
| ID. | °C | NH₃⁽*⁾ | CPLM | ACN | ACAM | Water | Other\hat{ } | NH₃^{(&)} | CLDIM | DNAC | ACN | Tars |
| 8a | 225 | 97.1 | 0.0 | 1.3 | 0.1 | 0.2 | 1.3 | 89.3 | 4.9 | 2.3 | 0.2 | 2.3 |
| 8b | 250 | 96.7 | 0.0 | 1.5 | 0.1 | 0.3 | 1.5 | 90.8 | 5.4 | 0.2 | <0.1 | 3.5 |
| 8c | 275 | 95.8 | 0.5 | 1.6 | 0.1 | 0.3 | 1.7 | 74.9 | 6.3 | <0.1 | <0.1 | 18.7 |
| 8d | 300 | 93.7 | 0.9 | 2.3 | 0.1 | 0.4 | 2.6 | 60.3 | 0.0 | 0.2 | <0.1 | 39.0 |
| 8e | 325 | 92.9 | 1.4 | 2.4 | 0.1 | 0.4 | 2.8 | 47.5 | 0.5 | <0.1 | <0.1 | 52.0 |
| 8f | 350 | 91.7 | 2.1 | 2.5 | 0.1 | 0.5 | 3.2 | 27.5 | 0.6 | <0.1 | <0.1 | 71.3 |

\hat{ }The term “Other” includes low-MW species.
⁽*⁾The excess NH₃ can be recovered and recycled back to the ammonolysis step via step 410 (as shown in FIG. 4).
^{(&)}The NH₃ values represent the component likely in the dissolved state in liquid-phase.
The liquid-phase wt. % values are based on the remaining liquid mass at the end that excludes the unconverted polymer mass.

TABLE 5E
Ammonolysis of 50:50 (wt:wt) N66: N6-containing feed.

| | Ammonolysis Conditions | | | | | | | | | Ammonolysis |
|---|---|---|---|---|---|---|---|---|---|---|
| | | | Total | Unconverted | | Overall | Yield, %, of . . . | | Tars | Product |
| Ex. | Temp, | Time, | NH₃ | Mass in | Conversion | Monomers | N66 | N6 | formed, | Vapor-phase |
| ID. | °C | mins | fed, g | reactor, g | % | Yield, % | Monomers⁽¹⁾ | Monomers⁽²⁾ | % | (g) |
| 8a | 225 | 570 | 832 | 4.4 | 70.5 | 70.2 | 67.0 | 73.5 | 9.4 | 853.3 |
| 8b | 250 | 420 | 613 | 4.1 | 72.4 | 71.9 | 71.8 | 71.9 | 29.8 | 634.8 |
| 8c | 275 | 350 | 511 | 2.7 | 81.8 | 81.2 | 74.6 | 87.7 | 66.1 | 534.3 |
| 8d | 300 | 280 | 409 | 2.6 | 82.4 | 79.8 | 72.2 | 87.4 | 82.4 | 432.0 |
| 8e | 325 | 220 | 321 | 2.9 | 80.5 | 76.6 | 68.2 | 85.0 | 84.2 | 343.4 |
| 8f | 350 | 190 | 277 | 4.2 | 71.7 | 67.3 | 56.5 | 78.0 | 84.2 | 296.7 |

⁽¹⁾nylon 66 monomers (including precursor yields) for HMD, ADN, CVAM.
⁽²⁾nylon 6 monomers (including precursor yields) for CPLM, ACN, ACAM.

TABLE 5F
Ammonolysis of 50:50 (wt: wt) N66:N6-containing feed.

| Ex. | Temp, | Ammonolysis Step Products in vapor-phase, wt. % | | | | | | | | |
|---|---|---|---|---|---|---|---|---|---|---|
| ID. | °C | NH₃⁽*⁾ | CPLM | ACN | ACAM | ADN | HMD | CVAM | Water | Other\hat{ } |
| 8a | 225 | 97.3 | <0.1 | 0.6 | <0.1 | 0.2 | 0.3 | <0.1 | 0.2 | 1.2 |
| 8b | 250 | 96.3 | <0.1 | 0.8 | <0.1 | 0.3 | 0.5 | <0.1 | 0.3 | 1.7 |
| 8c | 275 | 95.3 | 0.2 | 1.0 | <0.1 | 0.4 | 0.6 | <0.1 | 0.3 | 2.1 |
| 8d | 300 | 94.3 | 0.3 | 1.2 | <0.1 | 0.5 | 0.7 | 0.1 | 0.4 | 2.6 |
| 8e | 325 | 93.1 | 0.5 | 1.3 | <0.1 | 0.6 | 0.8 | 0.1 | 0.5 | 3.1 |
| 8f | 350 | 93.1 | 0.7 | 1.3 | <0.1 | 0.6 | 0.8 | 0.1 | 0.5 | 3.1 |

\hat{ }The term “Other” includes low-MW species.
⁽*⁾The excess NH₃ can be recovered and recycled back to the ammonolysis step via step 410 [as shown in FIG. 4).
(&) The NH₃ values represent the component likely in the dissolved state in liquid-phase.

TABLE 5G
Ammonolysis of 50:50 (wt:wt) N66:N6-containing feed.

| Ex. | Temp, | Ammonolysis Step Products in liquid-phase, wt. % | | | | | | |
|---|---|---|---|---|---|---|---|---|
| ID. | °C | NH₃^{(&)} | CO₂^{(&)} | DNAC | CLDIM | Tars | ACN | Other\hat{ } |
| 8a | 225 | 87.0 | 0.1 | 0.2 | 2.9 | 9.4 | <0.1 | 0.4 |
| 8b | 250 | 66.5 | 0.6 | 0.1 | 2.7 | 29.8 | <0.1 | 0.3 |
| 8c | 275 | 30.2 | 2.8 | <0.1 | 0.8 | 66.1 | <0.1 | 0.1 |
| 8d | 300 | 11.7 | 5.9 | <0.1 | 0.0 | 82.4 | <0.1 | <0.1 |
| 8e | 325 | 6.5 | 9.3 | <0.1 | 0.0 | 84.2 | <0.1 | <0.1 |
| 8f | 350 | 4.5 | 11.2 | <0.1 | 0.0 | 84.2 | <0.1 | <0.1 |

\hat{ }The term “Other” includes low-MW species.
(*) The excess NH3 can be recovered and recycled back to the ammonolysis step via step 410 (as shown in FIG. 4).
^{(&)}The NH₃ and CO₂ values represent the components likely present in the dissolved state in liquid-phase.
The liquid-phase wt. % values are based on the remaining liquid mass at the end that excludes the unconverted polymer mass.

It is observed that the nylon 66-containing feed depolymerizes to its primary monomer, hexamethylenediamine (HMD), and monomer precursors, namely, adiponitrile (ADN) and cyanovaleramide (CVAM). Cyanovaleramide is a precursor of adipic acid that forms in the ammonolysis step. And adiponitrile is a precursor to HMD. The tar formation is believed to be due to the thermal decomposition of the other nylon 66 monomer, adipic acid, and other high-molecular weight species formed.

It is observed that the nylon 6-containing feed depolymerizes to its monomer caprolactam (CPLM), and its precursors, namely, aminocapronitrile (ACN) and aminocapramide (ACAM). The two caprolactam precursors, ACN and ACAM, can be chemically converted back to caprolactam and recovered. The tar formation is believed to be due to the thermal decomposition of high-molecular weight species. The liquid-phase primarily contains the tars and dimers formed.

It is observed that a 50:50 (wt:wt) mixed nylon 66:nylon 6 containing feed depolymerizes to nylon 6 monomer caprolactam (CPLM), and its precursors, namely, aminocapronitrile (ACN) and aminocapramide (ACAM), and also, nylon 66 primary monomer, hexamethylenediamine (HMD), and monomer precursors, namely, adiponitrile (ADN) and cyanovaleramide (CVAM)

In all above cases, significant tar formation is observed when the ammonolysis step is carried out at high temperatures. While the overall yields for nylon 6 monomers were not much impacted by tar formation, the monomer yields in the nylon 66 cases showed a drop as the tar formation increased. It is believed that the adipic acid is a likely precursor to tar formation when the mixed nylon feed contained nylon 66 component.

It is, therefore, desirable to have a method for nylon polymer recycle wherein tar formation can be substantially reduced and the desirable monomer product yields can be improved. It is also advantageous to have a method wherein less tar formation is better from processability and operating cost perspectives, such as less frequent equipment clean-up/shutdowns.

### Example 8. Ammonolysis of Nylon Oligomeric Intermediates

Method 400 for recycling nylon polymer, as described in Example 6 and schematically represented in FIG. 4, is performed in the presence of the pre-treatment step 406 for oligomeric intermediates. The nylon-containing stream, obtained from step 402 and/or step 404, is pre-treated according to the step described in Example 4. The dewatered nylon oligomeric intermediates feed is then fed to the ammonolysis step 408 for complete depolymerization in the presence of excess ammonia.

Unlike in Example 7 for the nylon 66-containing feed, it is unexpectedly observed that the nylon 66 oligomeric intermediates feed from the pre-treatment step 406 can be depolymerized at a much lower temperature and reduced excess ammonia in the ammonolysis step 408.

In one instance, a representative product from the sub-critical water pre-treatment step 406 is a nylon 66 oligomeric intermediates feed having a number-average molecular weight in the range of 600-1500 g/mol, for example, 1100 g/mol. This low-molecular weight feed is depolymerized in the ammonolysis step 408 at a temperature 50 °C lower as compared to the temperature needed for the nylon 66-containing feed illustrated in Example 7.

In another instance, a representative product from the microwave digestion pre-treatment step 406 is a nylon 66 oligomeric intermediates feed having a lower molecular weight than that of the nylon 66-containing feed. This low-molecular weight feed is depolymerized in the ammonolysis step 408 at a temperature 25 °C lower as compared to the temperature needed for the nylon 66-containing feed illustrated in Example 7.

Similar results are observed for the nylon 6 as well as mixed nylon 66:nylon 6 oligomeric intermediates product obtained from either of the two pre-treatment steps, i.e., sub-critical water pre-treatment (Example 4) and microwave digestion pre-treatment (Example 5), when compared to the nylon 6-containing feed.

The pre-treatment step 406 allows for one to operate the ammonolysis step 408 at low temperatures and reduced ammonia content. The tar formation is reduced when the pre-treatment step is performed before the ammonolysis step as disclosed. The monomer and monomer precursor product yields improve when the pre-treatment step 406 is performed.

### Example 9. Caprolactam Recovery from Nylon 6 Feedstock

A 500 cc resin kettle was used for the steam stripping process. The kettle included a mechanical stirrer, a N2 purge, a distilling head, and a condenser. During operation the condensate was collected as it exited the condenser. Steam, generated from deoxygenated distilled water, was introduced into the molten charge via a stainless-steel tube. The kettle was heated with an electric heating mantle. The temperature inside the kettle was controlled by adjusting the temperature at the mantle/kettle interface via thermocouple.

The first set of experiments was performed to demonstrate acid catalyzed steam stripping of caprolactam from nylon 6 feedstock. The nylon 6 feedstock was not pre-treated to obtain low-molecular weight oligomeric intermediates.

About 500 g of nylon 6 material was charged to the kettle along with about 14.2 g of NaH₂PO₄·H₂O and about 2.9 g of 85% phosphoric acid. About 90 cc/hr (water eq.) steam was fed to the kettle. An additional 25.4 g of nylon 6 feed was added at the end of each operating hour up to the third hour to replenish the nylon 6 as it depolymerized in the kettle. The catalyst concentration as 85% H₃PO₄ ranged between 2.8-3.7% by wt. The temperature in the reactor ranged between 297 °C and 301 °C during the 4 hours of operation. The caprolactam concentration in the distillate ranged between 32 and 37.3% by weight.

The second set of experiments was performed to demonstrate base catalyzed steam stripping of caprolactam from nylon 6 feedstock. About 100 g of nylon 6 feedstock, and about 85.7 g of 6-aminocaproic acid and about 26.1 g of NaOH (equivalent to about 100 g sodium aminocaproate) were charged to the kettle. About 180 cc/hr (water eq.) steam was fed continuously. An additional 100 g of nylon 6 feed was added at the end of each operating hour up to the third hour to replenish the nylon 6 as it depolymerized in the kettle. The catalyst concentration as NaOH ranged between 7.5-23% by wt. The temperature in the reactor ranged between 318-333 °C for the first four hours and between 280-318 °C for the next six hours of operation. The caprolactam concentration in the distillate ranged between 16-42.5% by wt. for the first four hours and between 7-38% by wt. for the next six hours of operation.

An experiment was performed similar to the first set except no catalyst was used. The temperature in the reactor ranged between 255 °C and 307 °C during the 5 hours of operation. The caprolactam concentration in the distillate ranged between about 10 and 17.4% by weight.

The overall monomer (caprolactam) recovery was low in this example when nylon 6 was not partially depolymerized to obtain low-molecular weight oligomeric intermediates.

### Example 10. Acid-Catalyzed Experiments with Mixed Nylon Feedstock (Nylon 6 and 66)

An acid catalyzed steam stripping process was performed for a mixed nylon feed containing 10:90 (wt:wt) nylon 66:nylon 6. This mixed nylon feed was not pre-treated to obtain low-molecular weight oligomeric intermediates. The same NaH₂PO₄·H₂O and H₃PO₄ catalyst system of Example 9 was used but at an initial level of 16.25% on the basis of 85% H₃PO₄. An additional feed including 25.5:2.8 (g/g) nylon 6:nylon 66 was added each hour up to one hour before the run ended. High rates of caprolactam stripping were observed. However, some nylon 66 decomposition products, mainly, adiponitrile, cyclopentanone, hexylamine, 6-aminocapronitrile and nylon 66 cyclic monomer, were detected. No HMD or adipic acid was observed. In the first 5 hours of operation, the temperature ranged between 245-317 °C, the catalyst composition as 85% H₃PO₄ ranged between 16-21 wt % and the caprolactam concentration in the distillate ranged between about 17-40 wt %.

An acid catalyzed steam stripping process was also performed for a mixed nylon feed containing 50:50 (wt:wt) nylon 66:nylon 6. The same NaH₂PO₄·H₂O and H₃PO₄ catalyst system of Example 9 was used but at an initial level of 17.7% on the basis of 85% H₃PO₄. An additional feed including about 13:13 (g/g) nylon 6:nylon 66 was added each hour during the 5 hour run. The temperature ranged between 265-295 °C and the caprolactam concentration in the distillate ranged between about 8-11.5 wt %. The distillate was relatively clean containing essentially only caprolactam, but with low amounts of nylon 66 degradation products, mainly, cyclopentanone.

The overall monomer recovery was low in this example when the mixed nylon feed was not partially depolymerized to obtain low-molecular weight oligomeric intermediates.

### Example 11. Base-Catalyzed Experiments with Mixed Nylon Feedstock (Nylon 6 and 66)

A base catalyzed steam stripping process was performed for a mixed nylon feed including about 50:50 (wt:wt) nylon 66:nylon 6. This mixed nylon feed was not pre-treated to obtain low-molecular weight oligomeric intermediates. The starting composition including 100 g each of nylon 6 and 66, and about 85.7 g of 6-aminocaproic acid and about 26.1 g of NaOH (equivalent to about 100 g sodium aminocaproate). About 90 cc/hr (water eq.) steam was fed to the kettle. An additional 12.7 g of each nylon feed was added at end of each operating hour up to the third hour. The catalyst concentration as NaOH ranged between 7.7-9.1% by wt. The temperature in the reactor ranged between 261 °C and 278 °C during the 4 hours of operation. The caprolactam concentration in the distillate ranged between 3.5-3.8% by weight, while the HMD concentration ranged between 2.7-5.1% by wt.

The overall monomer recovery was low in this example when the mixed nylon feed was not partially depolymerized to obtain low-molecular weight oligomeric intermediates.

### Example 12. Base-Catalyzed Experiments with Nylon 66

A base catalyzed steam stripping process was performed for nylon 66 feed. The nylon feed was not pre-treated to obtain low-molecular weight oligomeric intermediates. The starting composition was 200 g nylon 66, and about 85.7 g of 6-aminocaproic acid and about 26.1 g of NaOH (equivalent to about 100 g sodium aminocaproate). About 90 cc/hr (water eq.) steam was fed to the kettle. An additional 25.6 g of nylon 66 feed was added at end of each operating hour throughout the 6-hour run. The catalyst concentration as NaOH ranged between 7.8-10.2% by wt. The temperature in the reactor ranged between 260 °C and 283 °C. The HMD concentration in distillate ranged between 3.5-22.1% by wt. A small amount of caprolactam (<5%) was initially detected, which formed from aminocaproic acid component. It later decreased over time (to <1%) as it was consumed. The overall monomer recovery was low in this example when the mixed nylon feed was not partially depolymerized to obtain low-molecular weight oligomeric intermediates.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides a method of recycling a polyamide composition, the method comprising:
pre-treating the polyamide composition comprising a polyamide to produce a polyamide oligomer composition comprising polyamide oligomers having a lower molecular weight than the polyamide in the polyamide composition; and
subjecting the polyamide oligomer composition to ammonolysis to produce a polyamide precursor composition comprising polyamide oligomers and/or monomers having a lower molecular weight than the polyamide oligomers in the polyamide oligomer composition.

Aspect 2 provides the method of Aspect 1, wherein the polyamide composition is a uniform composition.

Aspect 3 provides the method of Aspect 2, wherein the uniform composition comprises uniform-sized solids, a semi-solid slurry, a slurry solution, a homogenized liquid solution of dissolved polymer, or a combination thereof.

Aspect 4 provides the method of any one of Aspects 1-3, wherein the polyamide composition is a particulate composition.

Aspect 5 provides the method of any one of Aspects 1-4, further comprising mechanically treating a polyamide starting composition to form the polyamide composition.

Aspect 6 provides the method of Aspect 5, wherein the mechanical treatment comprises size reduction, cutting, grinding, shredding, particle formation, or a combination thereof.

Aspect 7 provides the method of any one of Aspects 1-6, further comprising separating a mixed plastics stream that is greater than 5 wt % non-polyamide constituents to form the polyamide composition having less than or equal to 5 wt % non-polyamide constituents.

Aspect 8 provides the method of Aspect 7, wherein the separating comprises melting point separation, stain test separation, electrostatic separation, flotation separation, melt phase separation, hot water pressure technique, hot dissolution technique, cold dissolution technique, selective dissolution technique, or a combination thereof.

Aspect 9 provides the method of any one of Aspects 7-8, wherein the separating comprises flotation separation in water.

Aspect 10 provides the method of any one of Aspects 7-9, wherein the separating of the mixed plastics stream removes thermoset polymers, polyesters, polyolefins, polycarbonates, or a combination thereof.

Aspect 11 provides the method of any one of Aspects 7-10, wherein the separating of the mixed plastics stream removes PET, LDPE, LLDPE, PP, PVC, ABS rubber, polyacrylates, or a combination thereof.

Aspect 12 provides the method of any one of Aspects 1-11, wherein the polyamide in the polyamide composition comprises N4, N5, N6, N7, N10, N11, N12, N46, N56, N66, N610, N612, or a combination thereof.

Aspect 13 provides the method of any one of Aspects 1-12, wherein the polyamide in the polyamide composition comprises N6, N66, N56, N610, or a combination thereof.

Aspect 14 provides the method of any one of Aspects 1-13, wherein the polyamide in the polyamide composition comprises N66.

Aspect 15 provides the method of any one of Aspects 1-14, wherein the polyamide is 95 wt % to 100 wt % of the polyamide composition.

Aspect 16 provides the method of any one of Aspects 1-15, wherein the polyamide is 98 wt % to 100 wt % of the polyamide composition.

Aspect 17 provides the method of any one of Aspects 1-16, wherein the pre-treating comprises hot water treatment, sub-critical water treatment, super-critical water treatment, microwave treatment, enzymatic treatment, solvent dissolution, acid hydrolysis, base hydrolysis, or a combination thereof.

Aspect 18 provides the method of any one of Aspects 1-17, wherein the pre-treating comprises solvent dissolution, acid hydrolysis, base hydrolysis, or a combination thereof.

Aspect 19 provides the method of any one of Aspects 1-18, wherein the pre-treating comprises enzymatic treatment, sub-critical water treatment, microwave treatment, or a combination thereof.

Aspect 20 provides the method of any one of Aspects 1-19, wherein the pre-treating comprises enzymatic treatment, wherein the enzymatic treatment is performed at a temperature of 15 °C to 45 °C, a pH of 5 to 9, and at a pressure of 0.5 atm to 2 atm.

Aspect 21 provides the method of Aspect 20, wherein the enzymatic treatment is performed at a temperature of 20 °C to 30 °C, a pH of 6 to 9, and a pressure of 1 atm to 1.5 atm.

Aspect 22 provides the method of any one of Aspects 1-21, wherein the pre-treating comprises sub-critical water treatment, and wherein the sub-critical water treatment comprises treatment with water having a temperature of 200 °C to <373.9 °C and a pressure of 20 atm to 217.8 atm.

Aspect 23 provides the method of Aspect 22, wherein the sub-critical water treatment comprises treatment with water having a temperature of 200 °C to 300 °C and a pressure of 40 atm to 100 atm.

Aspect 24 provides the method of any one of Aspects 1-23, wherein the pre-treating comprises microwave treatment, and wherein the microwave treatment comprises subjecting to microwave energy in a solvent at a temperature of 100 °C to 500 °C at a pressure of 1 atm to 1,000 atm.

Aspect 25 provides the method of Aspect 24, wherein the microwave treatment comprises subjecting to microwave energy in a solvent at a temperature of 150 °C to 250 °C at a pressure of 20 atm to 80 atm.

Aspect 26 provides the method of any one of Aspects 1-25, wherein the pre-treating is performed for a duration of no more than 15 hours.

Aspect 27 provides the method of any one of Aspects 1-26, wherein the polyamide oligomer composition has a number-average molecular weight of polyamide oligomers therein of greater than or equal to 200 g/mol to less than or equal to 3,000 g/mol.

Aspect 28 provides the method of any one of Aspects 1-27, wherein the polyamide oligomer composition has a number-average molecular weight of polyamide oligomers therein of greater than or equal to 500 g/mol to less than or equal to 1,500 g/mol.

Aspect 29 provides the method of any one of Aspects 1-28, wherein the polyamide oligomer composition comprises dimers, trimers, tetramers, higher oligomers, or a combination thereof.

Aspect 30 provides the method of any one of Aspects 1-29, further comprising dewatering the polyamide oligomer composition.

Aspect 31 provides the method of any one of Aspects 1-30, wherein the ammonolysis comprises contacting the polyamide oligomer composition with a nitrogen source.

Aspect 32 provides the method of any one of Aspects 31, wherein the nitrogen source comprises gaseous ammonia, liquid ammonia, dissolved ammonia, ammoniacal solution, and ammonia-enriched medium, or a combination thereof.

Aspect 33 provides the method of any one of Aspects 31-32, wherein the nitrogen source is gaseous ammonia.

Aspect 34 provides the method of any one of Aspects 31-33, wherein the ammonolysis comprises contacting the polyamide oligomer composition with the nitrogen source at a reaction temperature of 200 °C to 350 °C and at a reaction pressure of 30 atm to 140 atm.

Aspect 35 provides the method of any one of Aspects 31-34, further comprising recovering, purifying, and recycling unreacted nitrogen source back for reuse in the ammonolysis.

Aspect 36 provides the method of any one of Aspects 1-35, wherein the polyamide precursor composition comprises polyamide monomers.

Aspect 37 provides the method of any one of Aspects 1-36, wherein polyamide monomers are 0 wt % to 100 wt % or 1 wt % 100 wt % of a total amount of polyamide monomers and polyamide oligomers in the polyamide precursor composition.

Aspect 38 provides the method of any one of Aspects 1-37, wherein polyamide monomers are 90 wt % to 100 wt % of a total amount of polyamide monomers and polyamide oligomers in the polyamide precursor composition.

Aspect 39 provides the method of any one of Aspects 1-38, wherein the polyamide precursor composition comprises hexamethylene diamine (HMD), aminocapronitrile, 6-aminocaproamide, dimethyl adipate, adipic acid, methyl 6-aminocaproate, or a combination thereof.

Aspect 40 provides the method of any one of Aspects 1-39, further comprising purifying, refining, or separating one or more components of the polyamide precursor composition.

Aspect 41 provides the method of any one of Aspects 1-40, further comprising polymerizing the polyamide precursor composition or one or more components thereof to form one or more polyamides.

Aspect 42 provides a method of recycling a polyamide composition, the method comprising:
pre-treating the polyamide composition comprising a polyamide to produce a polyamide oligomer composition comprising polyamide oligomers having a lower molecular weight than the polyamide in the polyamide composition, wherein the pre-treating comprises enzymatic treatment, sub-critical water treatment, microwave treatment, or a combination thereof; and
subjecting the polyamide oligomer composition to ammonolysis to produce a polyamide precursor composition comprising polyamide oligomers and/or monomers having a lower molecular weight than the polyamide oligomers in the polyamide oligomer composition.

Aspect 43 provides a method of recycling a polyamide composition, the method comprising:
separating a mixed plastics stream that is greater than 5 wt % non-polyamide constituents to form a polyamide starting composition having less than or equal to 5 wt % non-polyamide constituents;
mechanically treating the polyamide starting composition to produce the polyamide composition, wherein the polyamide composition has less than or equal to 5 wt % non-polyamide constituents;
pre-treating the polyamide composition comprising a polyamide to produce a polyamide oligomer composition comprising polyamide oligomers having a lower molecular weight than the polyamide in the polyamide composition, wherein the pre-treating comprises hot water treatment, sub-critical water treatment, super-critical water treatment, microwave treatment, enzymatic treatment, solvent dissolution, acid hydrolysis, base hydrolysis, or a combination thereof; and
subjecting the polyamide oligomer composition to ammonolysis to produce a polyamide precursor composition comprising polyamide oligomers and/or monomers having a lower molecular weight than the polyamide oligomers in the polyamide oligomer composition.

Aspect 44 provides a polyamide formed from the polyamide precursor composition of any one of Aspects 1-43.

Aspect 45 provides a method of recycling a polyamide composition, the method comprising:
pre-treating the polyamide composition comprising a polyamide to produce a polyamide oligomer composition comprising polyamide oligomers having a lower molecular weight than the polyamide in the polyamide composition, the pre-treating comprising enzymatic treatment.

Aspect 46 provides the method of Aspect 45, wherein the enzymatic treatment is performed at a temperature of 15 °C to 45 °C, a pH of 5 to 9, and at a pressure of 0.5 atm to 2 atm.

Aspect 47 provides the method of any one of Aspects 45-46, wherein the enzymatic treatment is performed at a temperature of 20 °C to 30 °C, a pH of 6 to 9, and a pressure of 1 atm to 1.5 atm.

Aspect 48 provides the method of any one of Aspects 45-47, wherein the enzymatic treatment is performed for a duration of no more than 15 hours.

Aspect 49 provides the method of any one of Aspects 45-48, further comprising mechanically treating a polyamide starting composition to form the polyamide composition.

Aspect 50 provides the method of any one of Aspects 45-49, further comprising separating a mixed plastics stream that is greater than 5 wt % non-polyamide constituents to form the polyamide composition having less than or equal to 5 wt % non-polyamide constituents.

Aspect 51 provides the method of any one of Aspects 45-50, wherein the polyamide in the polyamide composition comprises N4, N5, N6, N7, N10, N11, N12, N46, N56, N66, N610, N612, or a combination thereof.

Aspect 52 provides the method of any one of Aspects 45-51, wherein the polyamide oligomer composition has a number-average molecular weight of polyamide oligomers therein of greater than or equal to 200 g/mol to less than or equal to 3,000 g/mol.

Aspect 53 provides the method of any one of Aspects 45-52, wherein the polyamide oligomer composition has a number-average molecular weight of polyamide oligomers therein of greater than or equal to 500 g/mol to less than or equal to 1,500 g/mol.

Aspect 54 provides the method of any one of Aspects 45-53, wherein the polyamide oligomer composition comprises dimers, trimers, tetramers, higher oligomers, or a combination thereof.

Aspect 55 provides the method of any one of Aspects 45-54, further comprising subjecting the polyamide oligomer composition to ammonolysis to produce a polyamide precursor composition comprising polyamide oligomers and/or monomers having a lower molecular weight than the polyamide oligomers in the polyamide oligomer composition.

Aspect 56 provides the method of Aspect 55, further comprising polymerizing the polyamide precursor composition to form one or more polyamides therefrom.

Aspect 57 provides the method of any one of Aspects 55-56, wherein the ammonolysis comprises contacting the polyamide oligomer composition with a nitrogen source.

Aspect 58 provides the method of Aspect 57, wherein the nitrogen source comprises gaseous ammonia, liquid ammonia, dissolved ammonia, ammoniacal solution, and ammonia-enriched medium, or a combination thereof.

Aspect 59 provides the method of any one of Aspects 57-58, wherein the nitrogen source is gaseous ammonia.

Aspect 60 provides the method of any one of Aspects 57-59, wherein the ammonolysis comprises contacting the polyamide oligomer composition with the nitrogen source at a reaction temperature of 200 °C to 350 °C and at a reaction pressure of 30 atm to 140 atm.

Aspect 61 provides the method of any one of Aspects 57-60, further comprising recovering, purifying, and recycling unreacted nitrogen source back for reuse in the ammonolysis.

Aspect 62 provides the method of any one of Aspects 45-61, further comprising dewatering the polyamide oligomer composition.

Aspect 63 provides the method of any one of Aspects 45-62, further comprising polymerizing the polyamide oligomer composition to form one or more polyamides.

Aspect 64 provides a method of recycling a polyamide composition, the method comprising:
separating a mixed plastics stream that is greater than 5 wt % non-polyamide constituents to form a polyamide starting composition having less than or equal to 5 wt % non-polyamide constituents;
mechanically treating the polyamide starting composition to produce the polyamide composition, wherein the polyamide composition has less than or equal to 5 wt % non-polyamide constituents; and
pre-treating the polyamide composition comprising a polyamide to produce a polyamide oligomer composition comprising polyamide oligomers having a lower molecular weight than the polyamide in the polyamide composition, wherein the pre-treating comprises enzymatic treatment.

Aspect 65 provides a polyamide formed from the polyamide oligomer composition of any one of Aspects 45-64.

Aspect 66 provides the method or polyamide of any one or any combination of Aspects 1-65 optionally configured such that all elements or options recited are available to use or select from.

1. A method of recycling a polyamide composition, the method comprising:
pre-treating the polyamide composition comprising a polyamide to produce a polyamide oligomer composition comprising polyamide oligomers having a lower molecular weight than the polyamide in the polyamide composition; and
subjecting the polyamide oligomer composition to ammonolysis to produce a polyamide precursor composition comprising polyamide oligomers and/or monomers having a lower molecular weight than the polyamide oligomers in the polyamide oligomer composition.

2. The method of claim 1, wherein the polyamide composition comprises a particulate composition, a semi-solid slurry, a slurry solution, a homogenized liquid solution of dissolved polymer, or a combination thereof.

3. The method of claim 1, further comprising mechanically treating a polyamide starting composition to form the polyamide composition, wherein the mechanical treatment comprises size reduction, cutting, grinding, shredding, particle formation, or a combination thereof.

4. The method of claim 1, further comprising separating a mixed plastics stream that is greater than 5 wt % non-polyamide constituents to form the polyamide composition, wherein the polyamide composition has less than or equal to 5 wt % non-polyamide constituents, wherein the separating of the mixed plastics stream removes thermoset polymers, polyesters, polyolefins, polycarbonates, or a combination thereof.

5. The method of claim 1, wherein the polyamide in the polyamide composition comprises N4, N5, N6, N7, N10, N11, N12, N46, N56, N66, N610, N612, or a combination thereof, wherein the polyamide is 95 wt % to 100 wt % of the polyamide composition.

6. The method of claim 1, wherein the polyamide in the polyamide composition comprises N66.

7. The method of claim 1, wherein the pre-treating comprises hot water treatment, sub-critical water treatment, super-critical water treatment, microwave treatment, enzymatic treatment, solvent dissolution, acid hydrolysis, base hydrolysis, or a combination thereof.

8. The method of claim 1, wherein the polyamide oligomer composition has a number-average molecular weight of polyamide oligomers therein of greater than or equal to 200 g/mol to less than or equal to 3,000 g/mol.

9. The method of claim 1, wherein the pre-treating comprises enzymatic treatment, wherein the enzymatic treatment is performed at a temperature of 15 °C to 45 °C, a pH of 5 to 9, and at a pressure of 0.5 atm to 2 atm.

10. The method of claim 1, wherein the pre-treating comprises sub-critical water treatment, and wherein the sub-critical water treatment comprises treatment with water having a temperature of 200 °C to <373.9 °C and a pressure of 20 atm to 217.8 atm.

11. The method of claim 1, wherein the pre-treating comprises microwave treatment, and wherein the microwave treatment comprises subjecting to microwave energy in a solvent at a temperature of 100 °C to 500 °C and at a pressure of 1 atm to 1,000 atm.

12. The method of claim 1, wherein the ammonolysis comprises contacting the polyamide oligomer composition with a nitrogen source at a reaction temperature of 200 °C to 350 °C and at a reaction pressure of 30 atm to 140 atm, the nitrogen source comprising gaseous ammonia, liquid ammonia, dissolved ammonia, ammoniacal solution, an ammonia-enriched medium, or a combination thereof.

13. The method of claim 1, wherein polyamide monomers are 90 wt % to 100 wt % of a total amount of polyamide monomers and polyamide oligomers in the polyamide precursor composition.

14. The method of claim 1, further comprising polymerizing the polyamide precursor composition or one or more components thereof to form one or more polyamides.

15. A method of recycling a polyamide composition, the method comprising:
separating a mixed plastics stream that is greater than 5 wt % non-polyamide constituents to form a polyamide starting composition having less than or equal to 5 wt % non-polyamide constituents;
mechanically treating the polyamide starting composition to produce the polyamide composition, wherein the polyamide composition has less than or equal to 5 wt % non-polyamide constituents;
pre-treating the polyamide composition comprising a polyamide to produce a polyamide oligomer composition comprising polyamide oligomers having a lower molecular weight than the polyamide in the polyamide composition, wherein the pre-treating comprises sub-critical water treatment, enzymatic treatment, or a combination thereof, and
subjecting the polyamide oligomer composition to ammonolysis to produce a polyamide precursor composition comprising polyamide oligomers and/or monomers having a lower molecular weight than the polyamide oligomers in the polyamide oligomer composition.

16. A method of recycling a polyamide composition, the method comprising:
pre-treating the polyamide composition comprising a polyamide to produce a polyamide oligomer composition comprising polyamide oligomers having a lower molecular weight than the polyamide in the polyamide composition, the pre-treating comprising enzymatic treatment, wherein the enzymatic treatment is performed at a temperature of 15 °C to 45 °C, a pH of 5 to 9, and at a pressure of 0.5 atm to 2 atm for a duration of no more than 15 hours.

17. The method of claim 16, further comprising subjecting the polyamide oligomer composition to ammonolysis to produce a polyamide precursor composition comprising polyamide oligomers and/or monomers having a lower molecular weight than the polyamide oligomers in the polyamide oligomer composition.

18. The method of claim 17, further comprising polymerizing the polyamide precursor composition to form one or more polyamides therefrom.

19. The method of claim 16, further comprising polymerizing the polyamide oligomer composition to form one or more polyamides.

20. The method of claim 16, further comprising:
separating a mixed plastics stream that is greater than 5 wt % non-polyamide constituents to form a polyamide starting composition having less than or equal to 5 wt % non-polyamide constituents; and
mechanically treating the polyamide starting composition to produce the polyamide composition, wherein the polyamide composition has less than or equal to 5 wt % non-polyamide constituents.
